(19) United States
(12) Patent Application Publication
(10) Pub. No.: US 2025/0370794 A1
(43) Pub. Date: Dec. 4, 2025

(54) JOB SCHEDULING FOR A DATA MANAGEMENT SYSTEMS BASED ON JOB GROUPS

(71) Applicant: Rubrik, Inc., Palo Alto, CA (US)

(72) Inventors: Brian Yin, San Jose, CA (US); Sudarshan Parthasarathy, Sunnyvale, CA (US); Rajat Paliwal, Mountain View, CA (US); Chih Chieh Lee, Redwood City, CA (US)

(21) Appl. No.: 18/679,070

(22) Filed: May 30, 2024

(51) Int. Cl. G06F 9/48; G06F 9/52

(52) U.S. Cl. CPC G06F 9/4881; G06F 9/52

(57) ABSTRACT

Methods, systems, and devices for data management are described. A data management system (DMS) may provide backup and recovery services for customer computing systems or databases, which may involve scheduling jobs to perform the backup and recovery services. Each job may define a set of semaphores which may be acquired prior to execution of the job. The semaphores may be representative of an availability of computing resources associated with the DMS. Jobs may be grouped into job groups based on the semaphores associated with each job. Each job group may be scheduled independently by separate dispatchers or job schedulers. Within a job group, the associated dispatcher(s) may schedule jobs if the semaphore(s) associated with the job group are available. Within a job group, the associated dispatchers may refrain from dispatching additional jobs if the semaphore(s) for the job group are full until the semaphore(s) are available.

### FIELD OF TECHNOLOGY

The present disclosure relates generally to data management, including techniques for job scheduling for a data management system based on job groups.

### BACKGROUND

A data management system (DMS) may be employed to manage data associated with one or more computing systems. The data may be generated, stored, or otherwise used by the one or more computing systems, examples of which may include servers, databases, virtual machines, cloud computing systems, file systems (e.g., network-attached storage (NAS) systems), or other data storage or processing systems. The DMS may provide data backup, data recovery, data classification, or other types of data management services for data of the one or more computing systems. Improved data management may offer improved performance with respect to reliability, speed, efficiency, scalability, security, or ease-of-use, among other possible aspects of performance.

### BRIEF DESCRIPTION OF THE DRAWINGS

FIG. 1 illustrates an example of a computing environment that supports job scheduling for a data management system (DMS) based on job groups in accordance with aspects of the present disclosure.

FIG. 2 shows examples of job scheduling diagrams that supports job scheduling for a DMS based on job groups in accordance with aspects of the present disclosure.

FIG. 3 shows an example of a computing environment that supports job scheduling for a DMS based on job groups in accordance with aspects of the present disclosure.

FIG. 4 shows an example of a computing environment that supports job scheduling for a DMS based on job groups in accordance with aspects of the present disclosure.

FIG. 5 shows an example of a process flow that supports job scheduling for a DMS based on job groups in accordance with aspects of the present disclosure.

FIG. 6 shows a block diagram of an apparatus that supports job scheduling for a DMS based on job groups in accordance with aspects of the present disclosure.

FIG. 7 shows a block diagram of a DMS Manager that supports job scheduling for a DMS based on job groups in accordance with aspects of the present disclosure.

FIG. 8 shows a diagram of a system including a device that supports job scheduling for a DMS based on job groups in accordance with aspects of the present disclosure.

FIGS. 9 and 10 show flowcharts illustrating methods that support job scheduling for a DMS based on job groups in accordance with aspects of the present disclosure.

### DETAILED DESCRIPTION

A data management system (DMS) may include various nodes, clusters, and sub-systems that provide backup and recovery services for customer computing systems or databases. Across customer accounts, such backup and recovery processes may involve thousands or millions of jobs to perform the backup and recovery services. Jobs may be dispatched (e.g., scheduled) by job manager services of the DMS, which may periodically poll a data store for jobs to execute. Each job may define a set of semaphores which may be acquired prior to execution of the job. The semaphores may be representative of an availability of computing resources associated with the DMS (e.g., memory, disk space, communication channels within the DMS, networking capabilities with external computing objects). Accordingly, the semaphores may limit the number of concurrently running jobs (e.g., backup jobs, restore jobs) by the DMS.

In some examples, the job scheduler (also referred to as a job dispatcher or dispatcher) may periodically dispatch multiple jobs (e.g., hundreds or thousands of jobs). At a given periodic dispatch round, due to semaphores being full, many of the jobs (e.g., more than half) may not be dispatched. In such examples, the dispatcher may wait until the next dispatch round to attempt to dispatch the jobs that were not dispatched in the prior dispatch round due the corresponding semaphores being full, leading to delay. In other examples, to avoid iterating over every job in the data store at each periodic dispatch round, the job scheduler may stop dispatching jobs once any semaphore is full. Such examples, however, may lead to under-utilization of semaphores and thus delay in the execution of jobs.

Aspects of this disclosure relate to techniques to group jobs into job groups based on the semaphores associated with each job. For example, a job group may be defined as a set of jobs which share the same set of one or more semaphores. Each job group may be scheduled independently by separate dispatchers, thereby achieving higher scheduling parallelism as compared to a single dispatcher which schedules each job. Within a job group, if the semaphore(s) for the job group are full, the associated dispatcher(s) may refrain from dispatching additional jobs until the semaphore(s) are available. Accordingly, a job scheduler may not iterate over each job for the DMS at each dispatch round, and a job may not be delayed due to semaphores that are not associated with the job being full. The DMS may monitor the completion of jobs in order to schedule additional jobs in the same job group as semaphores become available to minimize the time that resources are underutilized.

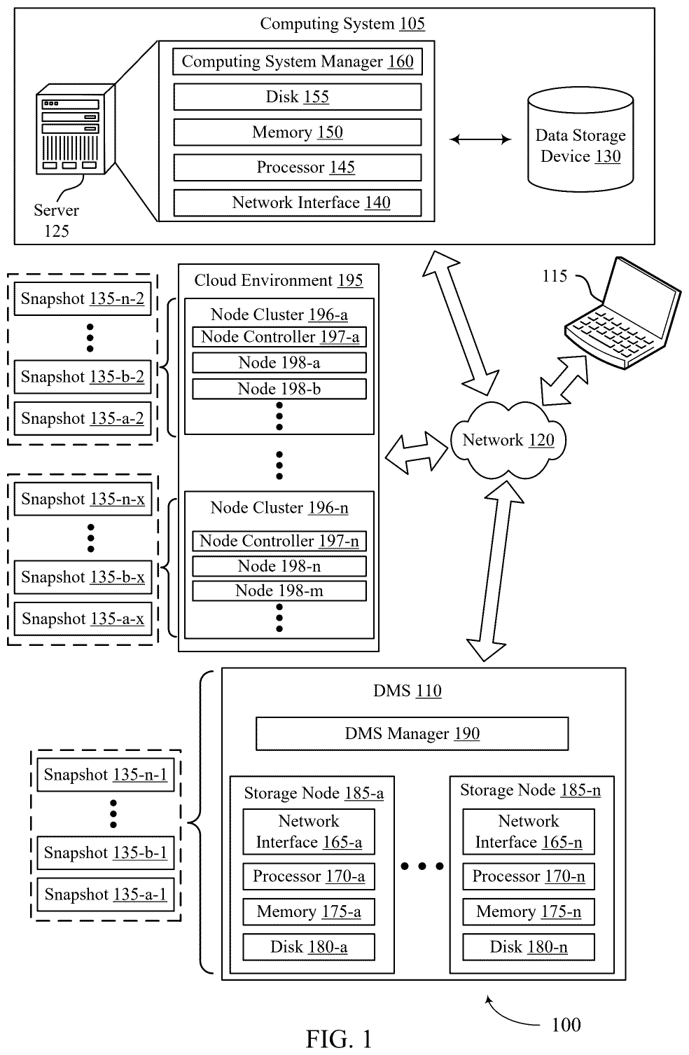

FIG. 1 illustrates an example of a computing environment 100 that supports job scheduling for a DMS based on job groups in accordance with aspects of the present disclosure. The computing environment 100 may include a computing system 105, a DMS 110, and one or more computing devices 115, which may be in communication with one another via a network 120. The computing system 105 may generate, store, process, modify, or otherwise use associated data, and the DMS 110 may provide one or more data management services for the computing system 105. For example, the DMS 110 may provide a data backup service, a data recovery service, a data classification service, a data transfer or replication service, one or more other data management services, or any combination thereof for data associated with the computing system 105.

The network 120 may allow the one or more computing devices 115, the computing system 105, and the DMS 110 to communicate (e.g., exchange information) with one another. The network 120 may include aspects of one or more wired networks (e.g., the Internet), one or more wireless networks (e.g., cellular networks), or any combination thereof. The network 120 may include aspects of one or more public networks or private networks, as well as secured or unsecured networks, or any combination thereof. The network 120 also may include any quantity of communications links and any quantity of hubs, bridges, routers, switches, ports or other physical or logical network components.

A computing device 115 may be used to input information to or receive information from the computing system 105, the DMS 110, or both. For example, a user of the computing device 115 may provide user inputs via the computing device 115, which may result in commands, data, or any combination thereof being communicated via the network 120 to the computing system 105, the DMS 110, or both. Additionally, or alternatively, a computing device 115 may output (e.g., display) data or other information received from the computing system 105, the DMS 110, or both. A user of a computing device 115 may, for example, use the computing device 115 to interact with one or more user interfaces (e.g., graphical user interfaces (GUIs)) to operate or otherwise interact with the computing system 105, the DMS 110, or both. Though one computing device 115 is shown in FIG. 1, it is to be understood that the computing environment 100 may include any quantity of computing devices 115.

A computing device 115 may be a stationary device (e.g., a desktop computer or access point) or a mobile device (e.g., a laptop computer, tablet computer, or cellular phone). In some examples, a computing device 115 may be a commercial computing device, such as a server or collection of servers. And in some examples, a computing device 115 may be a virtual device (e.g., a virtual machine). Though shown as a separate device in the example computing environment of FIG. 1, it is to be understood that in some cases a computing device 115 may be included in (e.g., may be a component of) the computing system 105 or the DMS 110.

The computing system 105 may include one or more servers 125 and may provide (e.g., to the one or more computing devices 115) local or remote access to applications, databases, or files stored within the computing system 105. The computing system 105 may further include one or more data storage devices 130. Though one server 125 and one data storage device 130 are shown in FIG. 1, it is to be understood that the computing system 105 may include any quantity of servers 125 and any quantity of data storage devices 130, which may be in communication with one another and collectively perform one or more functions ascribed herein to the server 125 and data storage device 130.

A data storage device 130 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 130 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server 125 may host (e.g., provide a database management system for) the database.

A server 125 may allow a client (e.g., a computing device 115) to download information or files (e.g., executable, text, application, audio, image, or video files) from the computing system 105, to upload such information or files to the computing system 105, or to perform a search query related to particular information stored by the computing system 105. In some examples, a server 125 may act as an application server or a file server. In general, a server 125 may refer to one or more hardware devices that act as the host in a client-server relationship or a software process that shares a resource with or performs work for one or more clients.

A server 125 may include a network interface 140, processor 145, memory 150, disk 155, and computing system manager 160. The network interface 140 may enable the server 125 to connect to and exchange information via the network 120 (e.g., using one or more network protocols). The network interface 140 may include one or more wireless network interfaces, one or more wired network interfaces, or any combination thereof. The processor 145 may execute computer-readable instructions stored in the memory 150 in order to cause the server 125 to perform functions ascribed herein to the server 125. The processor 145 may include one or more processing units, such as one or more central processing units (CPUs), one or more graphics processing units (GPUs), or any combination thereof. The memory 150 may comprise one or more types of memory (e.g., random access memory (RAM), static random access memory (SRAM), dynamic random access memory (DRAM), read-only memory (ROM), electrically erasable programmable read-only memory (EEPROM), Flash, etc.). Disk 155 may include one or more HDDs, one or more SSDs, or any combination thereof. Memory 150 and disk 155 may comprise hardware storage devices. The computing system manager 160 may manage the computing system 105 or aspects thereof (e.g., based on instructions stored in the memory 150 and executed by the processor 145) to perform functions ascribed herein to the computing system 105. In some examples, the network interface 140, processor 145, memory 150, and disk 155 may be included in a hardware layer of a server 125, and the computing system manager 160 may be included in a software layer of the server 125. In some cases, the computing system manager 160 may be distributed across (e.g., implemented by) multiple servers 125 within the computing system 105.

In some examples, the computing system 105 or aspects thereof may be implemented within one or more cloud computing environments, which may alternatively be referred to as cloud environments. Cloud computing may refer to Internet-based computing, wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 105 or aspects thereof through Software-as-a-Service (SaaS) or Infrastructure-as-a-Service (IaaS) services provided by the cloud environment. SaaS may refer to a software distribution model in which applications are hosted by a service provider and made available to one or more client devices over a network (e.g., to one or more computing devices 115 over the network 120). IaaS may refer to a service in which physical computing resources are used to instantiate one or more virtual machines, the resources of which are made available to one or more client devices over a network (e.g., to one or more computing devices 115 over the network 120).

In some examples, the computing system 105 or aspects thereof may implement or be implemented by one or more virtual machines. The one or more virtual machines may run various applications, such as a database server, an application server, or a web server. For example, a server 125 may be used to host (e.g., create, manage) one or more virtual machines, and the computing system manager 160 may manage a virtualized infrastructure within the computing system 105 and perform management operations associated with the virtualized infrastructure. The computing system manager 160 may manage the provisioning of virtual machines running within the virtualized infrastructure and provide an interface to a computing device 115 interacting with the virtualized infrastructure. For example, the computing system manager 160 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 155, the memory, the processor 145, the network interface 140, the data storage device 130, or any combination thereof in support of running the various applications. Storage resources (e.g., the disk 155, the memory 150, or the data storage device 130) that are virtualized may be accessed by applications as a virtual disk.

The DMS 110 may provide one or more data management services for data associated with the computing system 105 and may include DMS manager 190 and any quantity of storage nodes 185. The DMS manager 190 may manage operation of the DMS 110, including the storage nodes 185. Though illustrated as a separate entity within the DMS 110, the DMS manager 190 may in some cases be implemented (e.g., as a software application) by one or more of the storage nodes 185. In some examples, the storage nodes 185 may be included in a hardware layer of the DMS 110, and the DMS manager 190 may be included in a software layer of the DMS 110. In the example illustrated in FIG. 1, the DMS 110 is separate from the computing system 105 but in communication with the computing system 105 via the network 120. It is to be understood, however, that in some examples at least some aspects of the DMS 110 may be located within computing system 105. For example, one or more servers 125, one or more data storage devices 130, and at least some aspects of the DMS 110 may be implemented within the same cloud environment or within the same data center.

Storage nodes 185 of the DMS 110 may include respective network interfaces 165, processors 170, memories 175, and disks 180. The network interfaces 165 may enable the storage nodes 185 to connect to one another, to the network 120, or both. A network interface 165 may include one or more wireless network interfaces, one or more wired network interfaces, or any combination thereof. The processor 170 of a storage node 185 may execute computer-readable instructions stored in the memory 175 of the storage node 185 in order to cause the storage node 185 to perform processes described herein as performed by the storage node 185. A processor 170 may include one or more processing units, such as one or more CPUs, one or more GPUs, or any combination thereof. The memory 150 may comprise one or more types of memory (e.g., RAM, SRAM, DRAM, ROM, EEPROM, Flash, etc.). A disk 180 may include one or more HDDs, one or more SDDs, or any combination thereof. Memories 175 and disks 180 may comprise hardware storage devices. Collectively, the storage nodes 185 may in some cases be referred to as a storage cluster or as a cluster of storage nodes 185.

The DMS 110 may provide a backup and recovery service for the computing system 105. For example, the DMS 110 may manage the extraction and storage of snapshots 135 associated with different point-in-time versions of one or more target computing objects within the computing system 105. A snapshot 135 of a computing object (e.g., a virtual machine, a database, a filesystem, a virtual disk, a virtual desktop, or other type of computing system or storage system) may be a file (or set of files) that represents a state of the computing object (e.g., the data thereof) as of a particular point in time. A snapshot 135 may also be used to restore (e.g., recover) the corresponding computing object as of the particular point in time corresponding to the snapshot 135. In some cases, a computing object that is the subject of a snapshot 135 may be or include a collection of multiple objects (e.g., computing objects may have hierarchical relationships, with lower-level computing objects included within one or more higher-level computing objects). For example, a filesystem may include multiple files, and along with the filesystem being a computing object, the files therein may also be computing objects. Or, as another example, a database may include multiple tables, and along with the database being a computing object, the tables therein may also be computing objects. Thus, a snapshot may be of one or more computing objects, and a snapshot of a first computing object (e.g., a higher-level computing object) may also be a snapshot of each computing object (e.g., each lower-level computing object) that is included in (e.g., is a member or component of) the first computing object. Additionally, a snapshot may be of one or more lower-level computing objects individually (e.g., a snapshot of a lower-level computing object may be separate from another snapshot of another lower-level computing object, separate from another snapshot of a higher-level computing object that contains the lower-level computing object, or both).

A computing object of which a snapshot 135 may be generated may be referred to as snappable. Snapshots 135 may be generated at different times (e.g., periodically or on some other scheduled or configured basis) in order to represent the state of the computing system 105 or aspects thereof as of those different times. In some examples, a snapshot 135 may include metadata that defines a state of the computing object as of a particular point in time. For example, a snapshot 135 may include metadata associated with (e.g., that defines a state of) some or all data blocks included in (e.g., stored by or otherwise included in) the computing object. Snapshots 135 (e.g., collectively) may capture changes in the data blocks over time. Snapshots 135 generated for the target computing objects within the computing system 105 may be stored in one or more storage locations (e.g., the disk 155, memory 150, the data storage device 130) of the computing system 105, in the alternative or in addition to being stored within the DMS 110, as described below.

To obtain a snapshot 135 of a target computing object associated with the computing system 105 (e.g., of the entirety of the computing system 105 or some portion thereof, such as one or more databases, virtual machines, or filesystems within the computing system 105), the DMS manager 190 may transmit a snapshot request to the computing system manager 160. In response to the snapshot request, the computing system manager 160 may set the target computing object into a frozen state (e.g., a read-only state). Setting the target computing object into a frozen state may allow a point-in-time snapshot 135 of the target computing object to be stored or transferred.

In some examples, the computing system 105 may generate the snapshot 135 based on the frozen state of the computing object. For example, the computing system 105 may execute an agent of the DMS 110 (e.g., the agent may be software installed at and executed by one or more servers 125), and the agent may cause the computing system 105 to generate the snapshot 135 and transfer the snapshot 135 to the DMS 110 in response to the request from the DMS 110. In some examples, the computing system manager 160 may cause the computing system 105 to transfer, to the DMS 110, data that represents the frozen state of the target computing object, and the DMS 110 may generate a snapshot 135 of the target computing object based on the corresponding data received from the computing system 105.

Once the DMS 110 receives, generates, or otherwise obtains a snapshot 135, the DMS 110 may store the snapshot 135 at one or more of the storage nodes 185. The DMS 110 may store a snapshot 135 at multiple storage nodes 185, for example, for improved reliability. Additionally, or alternatively, snapshots 135 may be stored in some other location connected with the network 120. For example, the DMS 110 may store more recent snapshots 135 at the storage nodes 185, and the DMS 110 may transfer less recent snapshots 135 via the network 120 to a cloud environment (which may include or be separate from the computing system 105) for storage at the cloud environment, a magnetic tape storage device, or another storage system separate from the DMS 110.

Updates made to a target computing object that has been set into a frozen state may be written by the computing system 105 to a separate file (e.g., an update file) or other entity within the computing system 105 while the target computing object is in the frozen state. After the snapshot 135 (or associated data) of the target computing object has been transferred to the DMS 110, the computing system manager 160 may release the target computing object from the frozen state, and any corresponding updates written to the separate file or other entity may be merged into the target computing object.

In response to a restore command (e.g., from a computing device 115 or the computing system 105), the DMS 110 may restore a target version (e.g., corresponding to a particular point in time) of a computing object based on a corresponding snapshot 135 of the computing object. In some examples, the corresponding snapshot 135 may be used to restore the target version based on data of the computing object as stored at the computing system 105 (e.g., based on information included in the corresponding snapshot 135 and other information stored at the computing system 105, the computing object may be restored to its state as of the particular point in time). Additionally, or alternatively, the corresponding snapshot 135 may be used to restore the data of the target version based on data of the computing object as included in one or more backup copies of the computing object (e.g., file-level backup copies or image-level backup copies). Such backup copies of the computing object may be generated in conjunction with or according to a separate schedule than the snapshots 135. For example, the target version of the computing object may be restored based on the information in a snapshot 135 and based on information included in a backup copy of the target object generated prior to the time corresponding to the target version. Backup copies of the computing object may be stored at the DMS 110 (e.g., in the storage nodes 185) or in some other location connected with the network 120 (e.g., in a cloud environment, which in some cases may be separate from the computing system 105).

In some examples, the DMS 110 may restore the target version of the computing object and transfer the data of the restored computing object to the computing system 105. And in some examples, the DMS 110 may transfer one or more snapshots 135 to the computing system 105, and restoration of the target version of the computing object may occur at the computing system 105 (e.g., as managed by an agent of the DMS 110, where the agent may be installed and operate at the computing system 105).

In response to a mount command (e.g., from a computing device 115 or the computing system 105), the DMS 110 may instantiate data associated with a point-in-time version of a computing object based on a snapshot 135 corresponding to the computing object (e.g., along with data included in a backup copy of the computing object) and the point-in-time. The DMS 110 may then allow the computing system 105 to read or modify the instantiated data (e.g., without transferring the instantiated data to the computing system). In some examples, the DMS 110 may instantiate (e.g., virtually mount) some or all of the data associated with the point-in-time version of the computing object for access by the computing system 105, the DMS 110, or the computing device 115.

In some examples, the DMS 110 may store different types of snapshots 135, including for the same computing object. For example, the DMS 110 may store both base snapshots 135 and incremental snapshots 135. A base snapshot 135 may represent the entirety of the state of the corresponding computing object as of a point in time corresponding to the base snapshot 135. A base snapshot 135 may alternatively be referred to as a full snapshot 135. An incremental snapshot 135 may represent the changes to the state—which may be referred to as the delta—of the corresponding computing object that have occurred between an earlier or later point in time corresponding to another snapshot 135 (e.g., another base snapshot 135 or incremental snapshot 135) of the computing object and the incremental snapshot 135. In some cases, some incremental snapshots 135 may be forward-incremental snapshots 135 and other incremental snapshots 135 may be reverse-incremental snapshots 135. To generate a base snapshot 135 of a computing object using a forward-incremental snapshot 135, the information of the forward-incremental snapshot 135 may be combined with (e.g., applied to) the information of an earlier base snapshot 135 of the computing object along with the information of any intervening forward-incremental snapshots 135, where the earlier base snapshot 135 may include a base snapshot 135 and one or more reverse-incremental or forward-incremental snapshots 135. To generate a base snapshot 135 of a computing object using a reverse-incremental snapshot 135, the information of the reverse-incremental snapshot 135 may be combined with (e.g., applied to) the information of a later base snapshot 135 of the computing object along with the information of any intervening reverse-incremental snapshots 135.

In some examples, the DMS 110 may provide a data classification service, a malware detection service, a data transfer or replication service, backup verification service, or any combination thereof, among other possible data management services for data associated with the computing system 105. For example, the DMS 110 may analyze data included in one or more computing objects of the computing system 105, metadata for one or more computing objects of the computing system 105, or any combination thereof, and based on such analysis, the DMS 110 may identify locations within the computing system 105 that include data of one or more target data types (e.g., sensitive data, such as data subject to privacy regulations or otherwise of particular interest) and output related information (e.g., for display to a user via a computing device 115). Additionally, or alternatively, the DMS 110 may detect whether aspects of the computing system 105 have been impacted by malware (e.g., ransomware). Additionally, or alternatively, the DMS 110 may relocate data or create copies of data based on using one or more snapshots 135 to restore the associated computing object within its original location or at a new location (e.g., a new location within a different computing system 105). Additionally, or alternatively, the DMS 110 may analyze backup data to ensure that the underlying data (e.g., user data or metadata) has not been corrupted. The DMS 110 may perform such data classification, malware detection, data transfer or replication, or backup verification, for example, based on data included in snapshots 135 or backup copies of the computing system 105, rather than live contents of the computing system 105, which may beneficially avoid adversely affecting (e.g., infecting, loading, etc.) the computing system 105.

In some examples, the DMS 110, and in particular the DMS manager 190, may be referred to as a control plane. The control plane may manage tasks, such as storing data management data or performing restorations, among other possible examples. The control plane may be common to multiple customers or tenants of the DMS 110. For example, the computing system 105 may be associated with a first customer or tenant of the DMS 110, and the DMS 110 may similarly provide data management services for one or more other computing systems associated with one or more additional customers or tenants. In some examples, the control plane may be configured to manage the transfer of data management data (e.g., snapshots 135 associated with the computing system 105) to a cloud environment 195 (e.g., Microsoft Azure or Amazon Web Services). In addition, or as an alternative, to being configured to manage the transfer of data management data to the cloud environment 195, the control plane may be configured to transfer metadata for the data management data to the cloud environment 195. The metadata may be configured to facilitate storage of the stored data management data, the management of the stored management data, the processing of the stored management data, the restoration of the stored data management data, and the like.

Each customer or tenant of the DMS 110 may have a private data plane, where a data plane may include a location at which customer or tenant data is stored. For example, each private data plane for each customer or tenant may include a node cluster 196 across which data (e.g., data management data, metadata for data management data, etc.) for a customer or tenant is stored. Each node cluster 196 may include a node controller 197 which manages the nodes 198 of the node cluster 196. As an example, a node cluster 196 for one tenant or customer may be hosted on Microsoft Azure, and another node cluster 196 may be hosted on Amazon Web Services. In another example, multiple separate node clusters 196 for multiple different customers or tenants may be hosted on Microsoft Azure. Separating each customer or tenant's data into separate node clusters 196 provides fault isolation for the different customers or tenants and provides security by limiting access to data for each customer or tenant.

The control plane (e.g., the DMS 110, and specifically the DMS manager 190) manages tasks, such as storing backups or snapshots 135 or performing restorations, across the multiple node clusters 196. For example, as described herein, a node cluster 196-a may be associated with the first customer or tenant associated with the computing system 105. The DMS 110 may obtain (e.g., generate or receive) and transfer the snapshots 135 associated with the computing system 105 to the node cluster 196-a in accordance with a service level agreement for the first customer or tenant associated with the computing system 105. For example, a service level agreement may define backup and recovery parameters for a customer or tenant such as snapshot generation frequency, which computing objects to backup, where to store the snapshots 135 (e.g., which private data plane), and how long to retain snapshots 135. As described herein, the control plane may provide data management services for another computing system associated with another customer or tenant. For example, the control plane may generate and transfer snapshots 135 for another computing system associated with another customer or tenant to the node cluster 196-n in accordance with the service level agreement for the other customer or tenant.

To manage tasks, such as storing backups or snapshots 135 or performing restorations, across the multiple node clusters 196, the control plane (e.g., the DMS manager 190) may communicate with the node controllers 197 for the various node clusters via the network 120. For example, the control plane may exchange communications for backup and recovery tasks with the node controllers 197 in the form of transmission control protocol (TCP) packets via the network 120.

As described herein, to perform backup services (e.g., capturing and storing of snapshots 135) and/or recovery services (e.g., restoring a computing system 105 using a snapshot 135), the DMS 110 may schedule jobs associated with the backup and recovery services. Each job may involve the use of computing resources of the DMS 110. For example, such resources may involve memory of the DMS, disk space of the DMS, communication channels within the DMS, the network 120 (e.g., communication channels with the cloud environment 195 and/or the computing system 105), or any combination thereof. In some examples, an external resource associated with a particular job (e.g., the cloud environment 195 and/or the computing system 105) may have a rate limiter which may restrict a number of requests to a given quantity per time period (e.g., per second), which rate limiter may be considered a computing resource of the DMS 110 with respect to scheduling jobs. Such computing resources of the DMS 110 may logically be represented as semaphores. Accordingly, each job to be performed by the DMS 110 (e.g., to perform a scheduled backup or recovery service) may define a set of semaphores which may be acquired prior to execution of the job. Some jobs may involve the use of the same resources of the DMS (e.g., and accordingly the same semaphores). Accordingly, the semaphores may limit the number of concurrently running jobs by the DMS 110. For example, a semaphore may limit the number of parallel jobs that may be run on the same resource. A job scheduler of the DMS 110 may schedule jobs for the DMS 110 based on an availability of semaphores.

In some examples, the DMS 110 may group jobs into job groups based on the semaphores associated with each job. For example, a job group may be defined as a set of jobs which share the same set of one or more semaphores. Each job group may be scheduled independently by separate dispatchers (e.g., job schedulers of the DMS 110), thereby achieving higher scheduling parallelism as compared to a single dispatcher which schedules each job. Scheduling a job, also referred to as dispatching a job, may involve acquiring the relevant semaphore(s) for the job, checking that the job is valid, and assigning the job to a work queue of the DMS 110. One or more job executors of the DMS 110 may execute jobs at the work queue. Within a job group, if the semaphore(s) for the job group are full, the associated dispatcher(s) may refrain from dispatching additional jobs until the semaphore(s) are available (e.g., have capacity and are available to be acquired). Accordingly, a job scheduler associated with a given job group may not iterate over each job for the DMS 110 at each dispatch round, and instead may dispatch jobs within the given job group. Additionally, by assigning jobs to job groups and dispatching jobs using dedicated dispatchers per job group, a given job may not be delayed due to semaphores that are not associated with the given job being full (e.g., unavailable). The DMS 110 may monitor the completion of jobs in order to schedule additional jobs in the same job group as the corresponding semaphores become available in order to minimize the time that resources are underutilized.

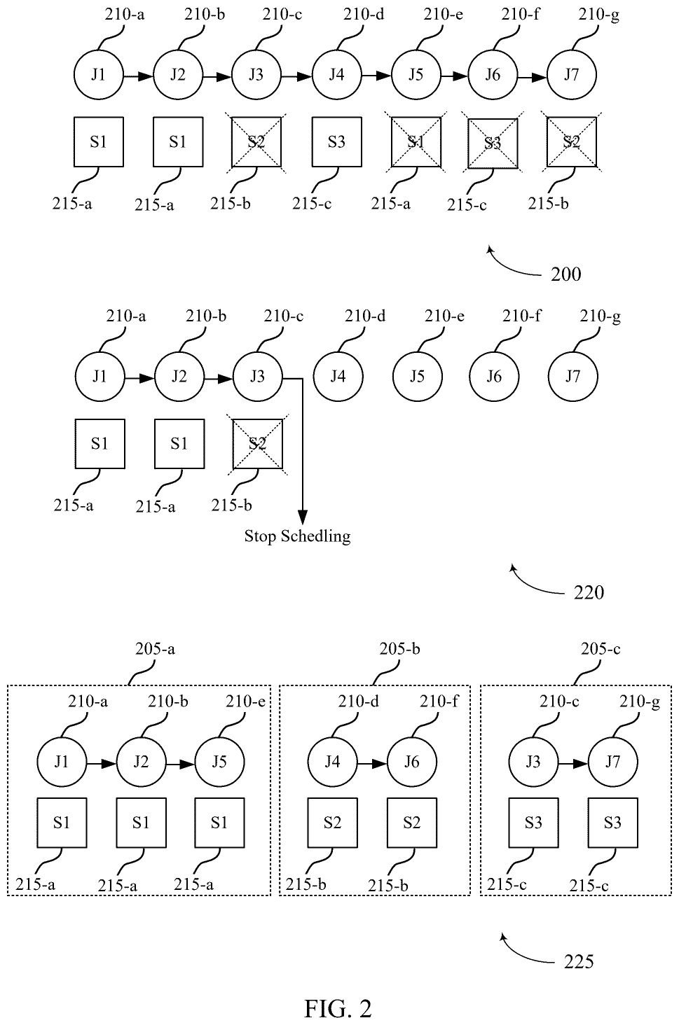

FIG. 2 shows examples of a job scheduling diagram 200, a job scheduling diagram 220, and a job scheduling diagram 225 that support job scheduling for a DMS based on job groups in accordance with aspects of the present disclosure. The job scheduling diagram 200, the job scheduling diagram 220, and the job scheduling diagram 225 may implement or may be implemented by one or more aspects of the computing environment 100. For example, the jobs 210 may be executed by a DMS 110 as described herein using resources of the DMS 110, where the semaphores 215 may be logical representations of the resources of the DMS 110.

In some examples, as shown in the job scheduling diagram 200, jobs 210 may be processed and scheduled in a serial fashion. In some examples, the jobs 210 (e.g., the job 210-a, the job 210-b, the job 210-c, the job 210-d, the job 210-e, the job 210-f, and the job 210-g) may be processed and scheduled per customer. Such serial scheduling however may lead to some inefficiencies such as wasted resources when attempting to dispatch jobs whose corresponding semaphores are already full or under-utilization of resources, thus decreasing job throughput in the DMS 110.

For example, as shown in the job scheduling diagram 200, the jobs 210 (e.g., the job 210-a, the job 210-b, the job 210-c, the job 210-d, the job 210-e, the job 210-f, and the job 210-g) may be ready to be dispatched for execution, and each job 210 may be associated with one of the semaphores 215 (the semaphore 215-a, the semaphore 215-b, and the semaphore 215-c). For example, a given job 210 must acquire the associated semaphore prior to execution of the job, and such acquisition may be performed by the job scheduler of the DMS 110. In the scenario of the job scheduling diagram 200, the semaphore 215-b may be unavailable (e.g., due to use by other jobs). After the job 210-a and the job 210-b are scheduled, the semaphore 215-a may be unavailable. After the job 210-d is scheduled, the semaphore 215-c may be unavailable. The job scheduler in the job scheduling diagram 200 may attempt to process all seven of the jobs 210 in the same dispatch round even though over half of the jobs are not able to be dispatched due to the unavailability of the corresponding semaphores (e.g., the job 210-c, the job 210-e, the job 210-f, and the job 210-g may not be dispatched). Accordingly, the job scheduler may wait until a subsequent periodic dispatch round to reattempt to schedule the job 210-c, the job 210-e, the job 210-f, and the job 210-g for execution. In production, a DMS 110 may have hundreds of thousands of jobs to execute which, if using the serial dispatching technique of the job scheduling diagram 200, may have to wait to be dispatched due to semaphore unavailability, which may degrade the throughput of the DMS 110.

In some examples, as shown in the job scheduling diagram 220, to reduce iteration over the same jobs multiple times, the job scheduler of the DMS 110 may terminate dispatching within a periodic dispatch round once any semaphore is unavailable. For example, the job scheduler may schedule the job 210-a and the job 210-b based on the availability of the semaphore 215-a. The semaphore 215-b may be unavailable, however, and accordingly the job scheduler may terminate dispatching jobs once the job scheduler reaches the job 210-c associated with the semaphore 215-b. The job scheduler may restart dispatching jobs at the job 210-c at the next dispatch round. The job scheduling technique of the job scheduling diagram 220 may reduce the amount of time spent attempting to dispatch jobs whose corresponding semaphores are full, but may leave semaphores under-utilized. For example, the semaphore 215-a and the semaphore 215-c may be underutilized as compared to the job scheduling diagram 200. Such under-utilization of semaphores may result in reduced job throughput and downstream impacts. For example, such under-utilization may lead to a service level agreement miss for a backup job (e.g., capturing a snapshot later than scheduled in accordance with the service level agreement for a given computing object).

In some examples, as shown in the job scheduling diagram 225, to avoid the wasted time of attempting to dispatch jobs with full semaphores (as in the job scheduling diagram 200) and to avoid the under-utilization of semaphores (as in the job scheduling diagram 220), job groups 205 may be defined. A job group 205 may be defined as a set of jobs 210 that share the same set of semaphores (e.g., the same set of computing resources used to execute the jobs). For example, the job group 205-a may include the job 210-a, the job 210-b, and the job 210-e which are associated with the semaphore 215-a; the job group 205-b may include the job 210-d and the job 210-f which are associated with the semaphore 215-b, and the job group 205-c may include the job 210-c and the job 210-g which are associated with the semaphore 215-c. Each job group 205 may be processed for scheduling independently by separate dispatcher(s) dedicated to the job group, thereby allowing for higher parallelism and reduced iteration over jobs. Within a job group 205, if the semaphore is full, the corresponding dispatcher(s) may wait until the semaphore is available to resume dispatching jobs. In some examples, dispatching jobs in accordance with separate dispatchers for separate job groups may increase throughput by up to 3 times across the DMS 110 as compared to serial dispatching using a single dispatcher.

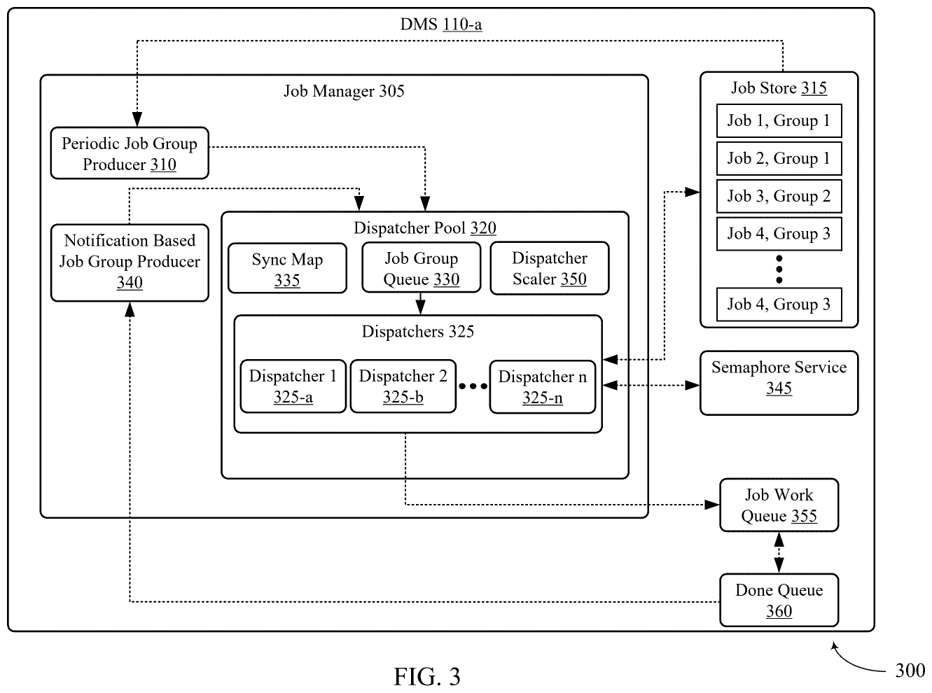

FIG. 3 shows an example of a computing environment 300 that supports job scheduling for a DMS based on job groups in accordance with aspects of the present disclosure. The computing environment 300 may implement or may be implemented by aspects of the computing environment 100. For example, the computing environment 300 may include a DMS 110-a, which may be an example of a DMS 110 as described herein.

The DMS 110-a may include a job manager 305 which may manage the intake and scheduling of jobs for the DMS 110-a to execute (e.g., for backup and/or recovery services provided by the DMS 110-a). The DMS 110-a may assign jobs (e.g., jobs 210 as described herein) to job groups (e.g., job groups 205 as described herein) based on the semaphores (e.g., semaphores 215 as described herein) associated with the jobs, and the DMS 110-a may store records of the jobs to execute and the associated job groups in a job store 315 (e.g., a database or other indexing mechanism). The DMS 110-a may automatically group jobs into job groups and index the jobs with the assigned job group IDs as the jobs are created at the DMS 110-a (for example, as the DMS 110-a determines which jobs will be executed to provide scheduled backup and recovery services). For example, metadata in the job store 315 may indicate the job ID and the associated job group (e.g., as a “job_group_id” field). Such indexing of the job group ID associated with each job may allow for efficient retrieval of jobs (e.g., all jobs) which belong to a given job group. In some examples, the job store 315 may include an indication of (e.g., metadata that indicates) the semaphores and/or resources associated with each job. A semaphore service 345 may manage the semaphore states (e.g., which semaphores exist, how much capacity each semaphore has, which jobs have acquired the semaphores).

The job manager 305 may include a periodic job group producer 310 which may periodically poll the job store 315 for the list of jobs to be executed by the DMS 110-a and may pass the job groups to a job group queue 330. For example, the periodic job group producer 310 may poll the job store 315 every 10 seconds. In some examples, the periodic job group producer may queue the job groups based on priority of the job groups. For example, the job store 315 may indicate a priority level associated with each job group. The dispatcher pool 320 may generate dispatchers based on the job groups identified in the job group queue 330. A dispatcher 325 may be a thread which pulls jobs from the job store 315 and dispatches the jobs for execution. Each job group may have one or more dedicated dispatchers 325 (e.g., the dispatcher 325-a may be associated with the job group 1, the dispatcher 325-b may be associated with the job group 2, etc.). Accordingly, the dispatcher pool 320 may include the multiple dispatchers 325. A sync map 335 may track if a job group is currently being dispatched to avoid race conditions which may occur from dispatching the same job in parallel. For example, multiple dispatchers 325 may be associated with the same job group, and the sync map may ensure that two dispatchers associated with the same job group do not attempt to dispatch the same job in the job group.

The dispatchers 325 may communicate with the semaphore service 345 to determine semaphore states. If a dispatcher 325 for a given job group determines that a semaphore associated with the given job group is full (e.g., has no available capacity or has less than a threshold amount of available capacity), the dispatcher 325 may stop dispatching jobs for that job group (e.g., until the dispatcher 325 determines that the semaphore has available capacity). If the dispatcher 325 for a given job group determines that the semaphore(s) associated with the given job group are available, the dispatcher may dispatch jobs within that job group.

In some cases, the dispatcher pool 320 may assign multiple dispatchers 325 to a given job group to increase throughput for that job group, for example based on the quantity of jobs to be executed within the job group. For example, the periodic job group producer 310 may indicate in the job group queue 330 the quantity of jobs assigned to each job group, and if the quantity of jobs assigned to a given job group exceeds a threshold, the dispatcher pool 320 may assign an additional dispatcher 325 to the job group. For example, a dispatcher scaler 350 may monitor to the quantity of active job groups which have jobs to execute (e.g., based on the job group queue 330 or based on querying the job store 315) and depending on the job load the dispatch scaler 350 may scale the number of dispatchers for each job group up or down. Further, the DMS 110-a may automatically scale job dispatchers as the number of job groups increases or decreases. In some examples, the quantity of dispatchers 325 assigned to each job group may depend on the priority level associated with each job group (e.g., as indicated in the job store 315 or the job group queue 330).

The dispatcher 325 for a given job may also ensure that the job group ID for each job attempted to be dispatched by that dispatcher 325 is correct. For example, jobs may change semaphores based on an availability of resources or a re-assignment of resources among semaphores. Accordingly, whenever a dispatcher 325 attempts to dispatch a job, the dispatcher 325 may hash the list of semaphores the job acquires to compute a job group ID for the job. If the computed job group ID differs from the job group ID assigned to the dispatcher 325 (e.g., as the dispatcher 325 is assigned to a job group), the dispatcher 325 may update the job group ID for the job in the job store 315 and the dispatcher 325 may refrain from dispatching that job. Accordingly, the dispatcher 325 associated with the correct and updated job group ID may pull the job from the job store 315 and schedule the job for execution using the correct semaphores. Thus, the DMS 110-a may implement automatic and seamless correction to the correct job group if jobs change semaphores or resources.

The DMS 110-a may execute jobs dispatched to the work queue 355 of the DMS 110-a using the resources associated with the semaphores for each job. For example, one or more job executors of the DMS 110-a may execute the jobs dispatched to the work queue 355. A done queue 360 may record which jobs dispatched to the work queue 355 have been completed. In some examples, the job manager 305 may include a notification based job group producer 340 which may monitor the done queue 360. The notification based job group producer 340 may identify which semaphores were released when each job in the done queue 360 was completed, and accordingly may update the job group queue 330 and/or may indicate to the corresponding dispatchers 325 which semaphore(s) are now available based on the completed jobs. Accordingly, in some examples, jobs may be executed based on notification or event-based triggering as soon as a resource (e.g., semaphore) is freed up to ensure that resources (e.g., semaphores) are saturated or fully utilized. In some examples, multiple job groups may be associated with a same semaphore, and based on the availability of a semaphore as indicated by the done queue 360, the dispatchers 325 may reschedule the dispatch for job groups which use that semaphore. In some examples, based on the jobs being completed as indicated by the done queue 360, the dispatchers 325 may reschedule for dispatch the highest priority job group which uses that semaphore. For example, the job store 315 may include a priority level for each job and/or job group, and scheduling between job groups that use a same semaphore may be based on priority. Rescheduling jobs for execution as semaphores become available may reduce the amount of time that resources associated with the semaphores are underutilized and may ensure highest priority jobs are executed first.

In some examples, multiple job groups may be associated with a same semaphore, and dispatchers 325 associated with the multiple job groups may schedule jobs based on the comparative priority levels associated with the job groups. For example, when two job groups share a semaphore, jobs of the job group with the higher priority level may be dispatched before jobs of the job group with the lower priority level. For example, jobs of the lower priority level job group may be dispatched if every job of the higher priority job group has been dispatched and the common semaphore has availability.

Some jobs may not be associated with any semaphores. Such jobs may be assigned to a NULL job group, which may be dispatched like other job groups. For example, the NULL job group may have a dedicated dispatcher 325 or dispatchers 325 in the dispatcher pool 320.

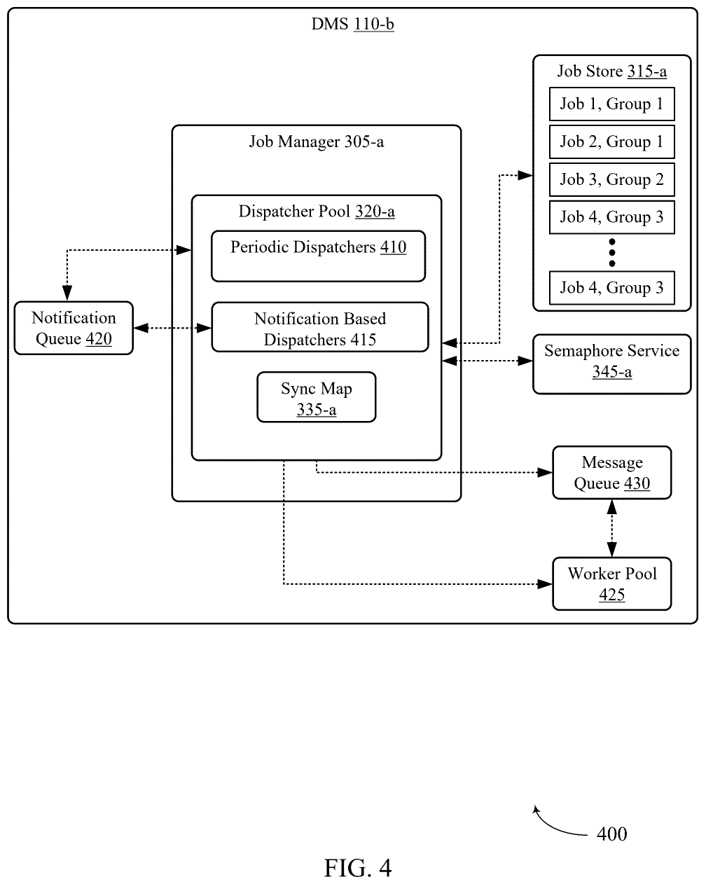

FIG. 4 shows an example of a computing environment 400 that supports job scheduling for a DMS based on job groups in accordance with aspects of the present disclosure. The computing environment 400 may implement or may be implemented by aspects of the computing environment 100. For example, the computing environment 400 may include a DMS 110-b, which may be an example of a DMS 110 as described herein.

The DMS 110-b may include a job manager 305-a which may manage the intake and scheduling of jobs for the DMS 110-b to execute (e.g., for backup and/or recovery services provided by the DMS 110-b). The DMS 110-b may assign jobs to job groups based on the semaphores associated with the jobs, and the DMS 110-b may store records of the jobs to execute and the associated job groups in a job store 315-a (e.g., a database or other indexing mechanism). For example, metadata in the job store 315-a may indicate the job ID and the associated job group (e.g., as a “job_group_id” field). Such indexing of the job group ID associated with each job may allow for efficient retrieval of jobs (e.g., all jobs) which belong to a given job group. In some examples, the job store 315-a may include an indication of (e.g., metadata that indicates) the semaphores and/or resources associated with each job. A semaphore service 345-a may manage the semaphore states (e.g., which semaphores exist, how much capacity each semaphore has, which jobs have acquired the semaphores).

The dispatcher pool 320-a may include periodic dispatchers 410 and notification based dispatchers 415. The periodic dispatchers 410 may include one or more periodic dispatchers 410 per job group that periodically poll the job store 315-a for jobs to schedule associated with the given job group.

When semaphores are released as jobs are completed by the worker pool 425 of the DMS 110-b (e.g., the job executor(s) of the DMS 110-b), instead of waiting until the next periodic dispatch cycle, the notification based dispatchers 415 may dispatch jobs associated with the released semaphores after release of the semaphores. In order to do so, a notification queue 420 may receive messages which indicate when a semaphore has been released as well as the job groups associated with that semaphore. For example, the worker pool 425 may indicate in a message queue 430 which jobs have been completed, and the job manager 305-a may monitor the message queue 430. The notification queue 420 may receive the messages which indicate when a semaphore has been released as well as the job groups associated with that semaphore from the job manager 305 based on the job manager 305-a monitoring the message queue 430. The notification queue 420 may be used to prioritize between job groups which share a common semaphore to ensure that the higher priority job group is scheduled first.

The notification based dispatchers 415 may pick up jobs from the job store 315-a based on the notification queue 420 (e.g., based on priority of the job groups and the release of semaphores as indicated in the notification queue 420). The quantity of notification based dispatchers 415 may be increased or decreased by auto-scaling logic based on the quantity of job groups and/or jobs per job group in the notification queue 420. The sync map 335-a may be used by both the periodic dispatchers 410 and the notification based dispatchers 415 to coordinate between the two types of dispatchers to ensure that the same job is not dispatched more than once.

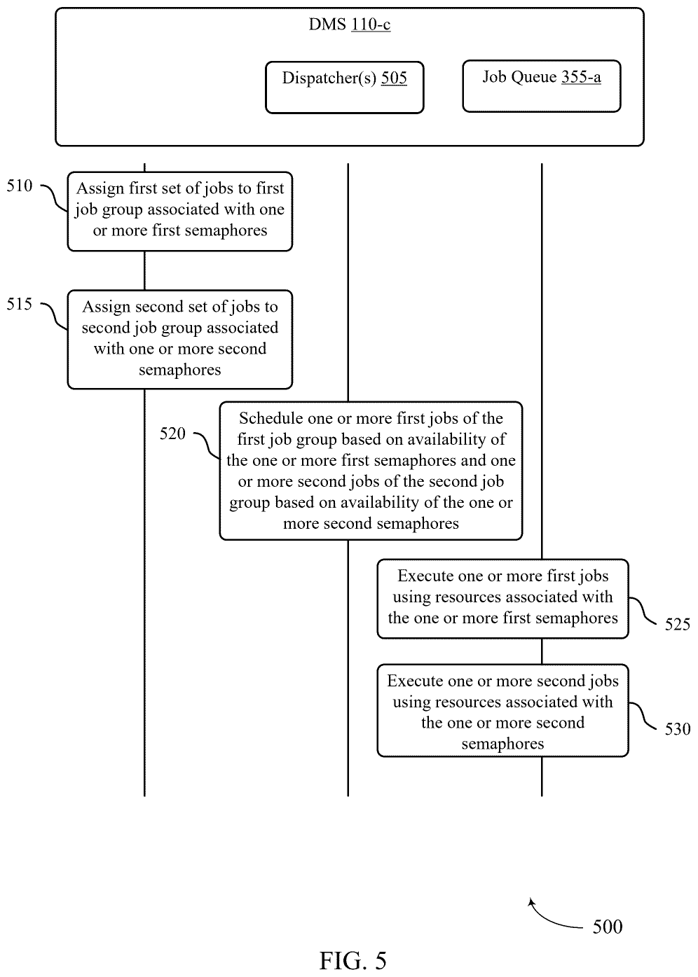

FIG. 5 shows an example of a process flow 500 that supports job scheduling for a DMS based on job groups in accordance with aspects of the present disclosure. The process flow 500 may implement or may be implemented by one or more aspects of the computing environment 100, the computing environment 300, or the computing environment 400. For example, the process flow 500 may include a DMS 110-c, which may be an example of a DMS 110 as described herein. The DMS 110-c may include one or more dispatchers 505, which may be examples of dispatchers 325, periodic dispatchers 410, or notification based dispatchers 415 as described herein. The DMS 110-c may include a work queue 355-a which may be an example of the work queue 355 as described herein. In the following description of the process flow 500, operations between the DMS 110-c, the one or more dispatchers 505, and the work queue 355-a may be added, omitted, or performed in a different order (with respect to the exemplary order shown).

At 510, the DMS 110-c may assign a first set of jobs to a first job group from a set of multiple job groups based on the first set of jobs and the first job group both being associated with one or more first semaphores.

At 515, the DMS 110-c may assign a second set of jobs to a second job group from the set of multiple job groups based on the second set of jobs and the second job group both being associated with one or more second semaphores.

At 520, the one or more dispatchers 505 may schedule for execution (e.g., dispatch) one or more first jobs assigned to the first job group based on the one or more first semaphores being available and one or more second jobs assigned to the second job group based on the one or more second semaphores being available.

At 525, the DMS 110-c may execute, based on the scheduling, the one or more first jobs dispatched to the work queue 355-a using one or more first resources of the DMS 110-c corresponding to the one or more first semaphores.

At 530, the DMS 110-c may execute, based on the scheduling, the one or more second jobs dispatched to the work queue 355-a using one or more second resources of the DMS 110-c corresponding to the one or more second semaphores.

In some examples, at 520 a first dispatcher of the one or more dispatchers 505 may schedule for execution the one or more first jobs and a second dispatcher of the one or more dispatchers 505 may schedule for execution the one or more second jobs. In such examples, the first dispatcher may be associated with the first job group and the second dispatcher may be associated with the second job group. For example, the DMS 110-c may initiate or assign at least one dispatcher per job group. In some examples, the scheduling for execution of the one or more first jobs by the first dispatcher occurs in parallel with the scheduling for execution of the one or more second jobs by the second dispatcher.

In some examples, the DMS 110-c may identify that a quantity of jobs assigned to the first job group exceeds a threshold. In such examples, the DMS 110-c may assign a set of multiple dispatchers to the first job group based on the quantity of jobs assigned to the first job group exceeding the threshold, and scheduling for execution the one or more first jobs assigned to the first job group at 520 may involve scheduling for execution a first subset of the one or more first jobs by a first dispatcher of the one or more dispatchers 505 and scheduling for execution a second subset of the one or more first jobs by a second dispatcher of the one or more dispatchers 505. For example, the DMS 110-c may scale the quantity of dispatchers for a given job group based on the quantity of jobs to dispatch within the job group.

In some examples, the DMS 110-c (e.g., the dispatcher(s) assigned to the first job group) may identify, at a first time subsequent to scheduling the one or more first jobs for execution at 520, an unavailability of at least one semaphore of the one or more first semaphores. In such examples, the DMS 110-c (e.g., the dispatcher(s) assigned to the first job group) may refrain, subsequent to the first time, from scheduling one or more additional jobs assigned to the first job group based on the at least one semaphore of the one or more first semaphores being unavailable. In some examples, the DMS 110-c (e.g., the dispatcher(s) assigned to the first job group) may identify, at a second time subsequent to the first time, that the one or more first semaphores are available. For example, the DMS 110-c may implement notification based scheduling which monitors for the completion of jobs in order to determine the freeing up of semaphores. In such examples, the DMS 110-c (e.g., the dispatcher(s) assigned to the first job group) may schedule for execution, at or subsequent to the second time, one or more jobs of the one or more additional jobs assigned to the first job group; and the DMS 110-c may execute, based on the scheduling at or subsequent to the second time, the one or more jobs of the one or more additional jobs using the one or more first resources of the DMS 110-c corresponding to the one or more first semaphores. In some examples, the DMS 110-c may identify a first priority of the first job group and a second priority of the second job group, where the first priority is higher than the second priority, and where at least one semaphore is included in both the one or more first semaphores and the one or more second semaphores. In some such examples, the DMS 110-c may identify, at a second time subsequent to the first time, that the one or more first semaphores are available. The DMS 110-c (e.g., the dispatcher(s) assigned to the first job group) may schedule for execution, at or subsequent to the second time, one or more jobs of the one or more additional jobs assigned to the first job group based on the first priority being higher than the second priority; and the DMS 110-c (e.g., the dispatcher(s) assigned to the second job group) may refrain from scheduling for execution, at or subsequent to the second time, one or more second additional jobs of the second job group based on the first priority being higher than the second priority.

In some examples, the DMS 110-c may assign a third set of jobs to a third job group from the set of multiple job groups based on the third set of jobs and the third job group both being associated with one or more third semaphores. In such examples, the one or more dispatchers 505 (e.g., the dispatcher(s) assigned to the third job group) may schedule for execution one or more third jobs assigned to the third job group based at least in part on the one or more third semaphores being available. In such examples, the DMS 110-c may execute, based at least in part on the scheduling, the one or more third jobs using one or more third resources of the DMS 110-c corresponding to the one or more third semaphores.

In some examples, the DMS 110-c may store, in a data store accessible to the DMS (e.g., the job store 315 as described herein), first metadata indicating that the first set of jobs and that the first set of jobs are associated with the first job group and second metadata indicating that the second set of jobs and that the second set of jobs are associated with the second job group. For example, the data store may index which jobs are assigned to which job groups. In some examples, the one or more dispatchers 505 may obtain the first metadata and the second metadata, and the scheduling at 520 may be based on the one or more dispatchers 505 obtaining the first and second metadata.

In some examples, the DMS 110-c may identify a first priority of the first job group and a second priority of the second job group, where the first priority is higher than the second priority, and where at least one semaphore is included in both the one or more first semaphores and the one or more second semaphores. In such examples, the scheduling at 520 may involve scheduling the one or more first jobs for execution prior to scheduling the one or more second jobs for execution based on the first priority being higher than the second priority.

In some examples, the one or more first resources and the one or more second resources may include memory of the DMS 110-c, disk space of the DMS 110-c, communication channels within the DMS 110-c, communication channels with external computing objects, rate limitations of external computing objects, or any combination thereof.

In some examples, the DMS 110-c may receive an indication to perform a backup operation or a recovery operation for a computing object, and the DMS 110-c may identify a set of multiple jobs associated with the backup operation or the recovery operation, where the set of multiple jobs includes the first set of jobs and the second set of jobs.

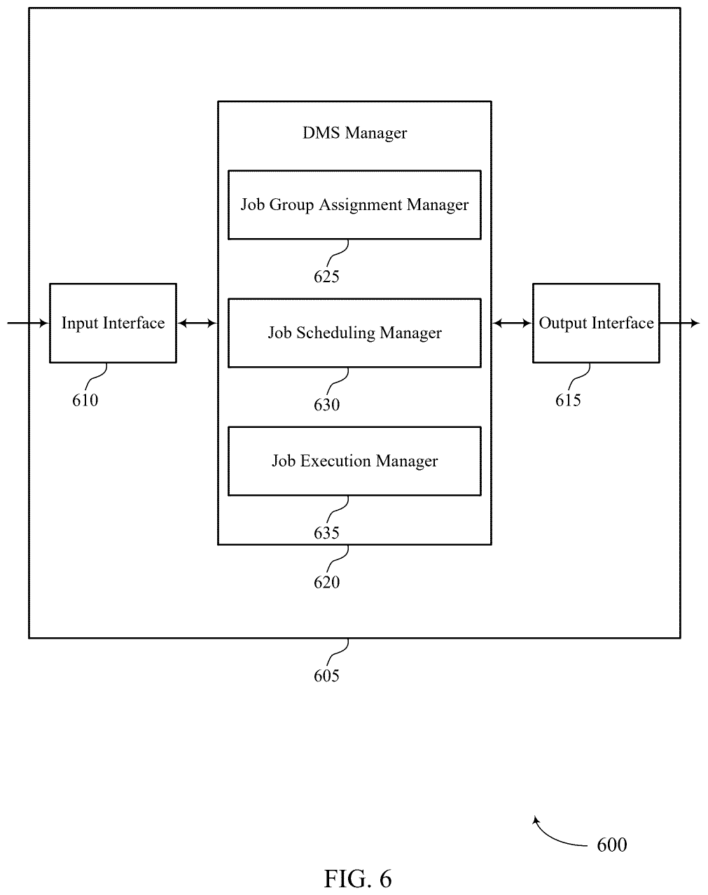

FIG. 6 shows a block diagram 600 of a system 605 that supports job scheduling for a DMS based on job groups in accordance with aspects of the present disclosure. In some examples, the system 605 may be an example of aspects of one or more components described with reference to FIG. 1, such as a DMS 110. The system 605 may include an input interface 610, an output interface 615, and a DMS Manager 620. The system 605 may also include one or more processors. Each of these components may be in communication with one another (e.g., via one or more buses, communications links, communications interfaces, or any combination thereof).

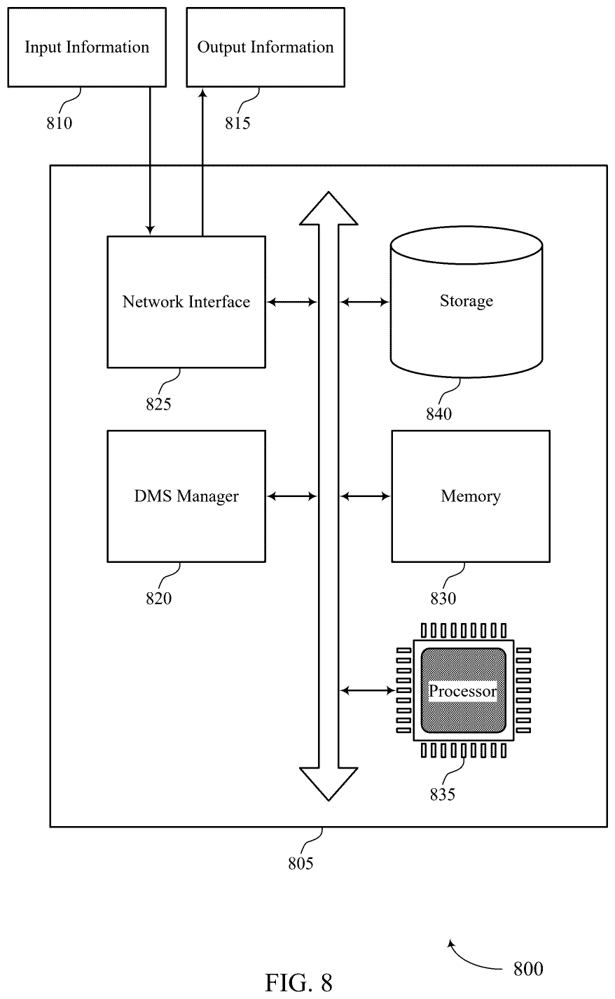

The input interface 610 may manage input signaling for the system 605. For example, the input interface 610 may receive input signaling (e.g., messages, packets, data, instructions, commands, or any other form of encoded information) from other systems or devices. The input interface 610 may send signaling corresponding to (e.g., representative of or otherwise based on) such input signaling to other components of the system 605 for processing. For example, the input interface 610 may transmit such corresponding signaling to the DMS Manager 620 to support job scheduling for a DMS based on job groups. In some cases, the input interface 610 may be a component of a network interface 825 as described with reference to FIG. 8.

The output interface 615 may manage output signaling for the system 605. For example, the output interface 615 may receive signaling from other components of the system 605, such as the DMS Manager 620, and may transmit such output signaling corresponding to (e.g., representative of or otherwise based on) such signaling to other systems or devices. In some cases, the output interface 615 may be a component of a network interface 825 as described with reference to FIG. 8.

For example, the DMS Manager 620 may include a job group assignment manager 625, a job scheduling manager 630, a job execution manager 635, or any combination thereof. In some examples, the DMS Manager 620, or various components thereof, may be configured to perform various operations (e.g., receiving, monitoring, transmitting) using or otherwise in cooperation with the input interface 610, the output interface 615, or both. For example, the DMS Manager 620 may receive information from the input interface 610, send information to the output interface 615, or be integrated in combination with the input interface 610, the output interface 615, or both to receive information, transmit information, or perform various other operations as described herein.

The job group assignment manager 625 may be configured as or otherwise support a means for assigning, by a DMS, a first set of jobs to a first job group from a set of multiple job groups based on the first set of jobs and the first job group both being associated with one or more first semaphores. The job group assignment manager 625 may be configured as or otherwise support a means for assigning, by the DMS, a second set of jobs to a second job group from the set of multiple job groups based on the second set of jobs and the second job group both being associated with one or more second semaphores. The job scheduling manager 630 may be configured as or otherwise support a means for scheduling for execution, by one or more dispatchers of the DMS, one or more first jobs assigned to the first job group based on the one or more first semaphores being available and one or more second jobs assigned to the second job group based on the one or more second semaphores being available. The job execution manager 635 may be configured as or otherwise support a means for executing, based on the scheduling, the one or more first jobs using one or more first resources of the DMS corresponding to the one or more first semaphores. The job execution manager 635 may be configured as or otherwise support a means for executing, based on the scheduling, the one or more second jobs using one or more second resources of the DMS corresponding to the one or more second semaphores.

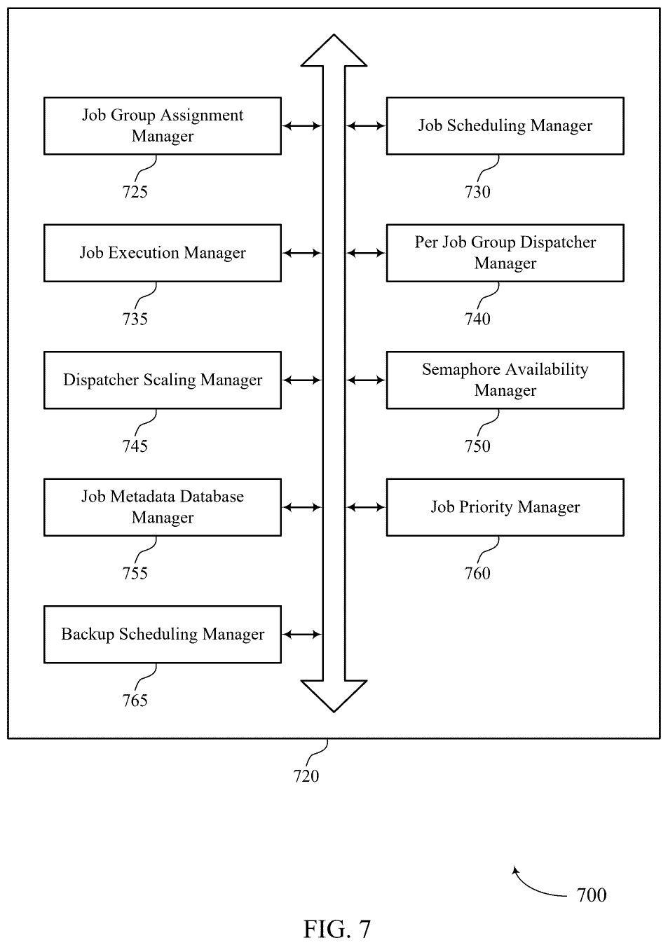

FIG. 7 shows a block diagram 700 of a DMS Manager 720 that supports job scheduling for a DMS based on job groups in accordance with aspects of the present disclosure. The DMS Manager 720 may be an example of aspects of a DMS Manager or a DMS Manager 620, or both, as described herein. The DMS Manager 720, or various components thereof, may be an example of means for performing various aspects of job scheduling for a DMS based on job groups as described herein. For example, the DMS Manager 720 may include a job group assignment manager 725, a job scheduling manager 730, a job execution manager 735, a per job group dispatcher manager 740, a dispatcher scaling manager 745, a semaphore availability manager 750, a job metadata database manager 755, a job priority manager 760, a backup scheduling manager 765, or any combination thereof. Each of these components, or components of subcomponents thereof (e.g., one or more processors, one or more memories), may communicate, directly or indirectly, with one another (e.g., via one or more buses, communications links, communications interfaces, or any combination thereof).

The job group assignment manager 725 may be configured as or otherwise support a means for assigning, by a DMS, a first set of jobs to a first job group from a set of multiple job groups based on the first set of jobs and the first job group both being associated with one or more first semaphores. In some examples, the job group assignment manager 725 may be configured as or otherwise support a means for assigning, by the DMS, a second set of jobs to a second job group from the set of multiple job groups based on the second set of jobs and the second job group both being associated with one or more second semaphores. The job scheduling manager 730 may be configured as or otherwise support a means for scheduling for execution, by one or more dispatchers of the DMS, one or more first jobs assigned to the first job group based on the one or more first semaphores being available and one or more second jobs assigned to the second job group based on the one or more second semaphores being available. The job execution manager 735 may be configured as or otherwise support a means for executing, based on the scheduling, the one or more first jobs using one or more first resources of the DMS corresponding to the one or more first semaphores. In some examples, the job execution manager 735 may be configured as or otherwise support a means for executing, based on the scheduling, the one or more second jobs using one or more second resources of the DMS corresponding to the one or more second semaphores.

In some examples, to support scheduling for execution the one or more first jobs and the one or more second jobs, the per job group dispatcher manager 740 may be configured as or otherwise support a means for scheduling for execution, by a first dispatcher of the one or more dispatchers, the one or more first jobs, where the first dispatcher is associated with the first job group. In some examples, to support scheduling for execution the one or more first jobs and the one or more second jobs, the per job group dispatcher manager 740 may be configured as or otherwise support a means for scheduling for execution, by a second dispatcher of the one or more dispatchers, the one or more second jobs, where the second dispatcher is associated with the second job group.

In some examples, the scheduling for execution of the one or more first jobs by the first dispatcher occurs in parallel with the scheduling for execution of the one or more second jobs by the second dispatcher.

In some examples, the dispatcher scaling manager 745 may be configured as or otherwise support a means for identifying, by the DMS, that a quantity of jobs assigned to the first job group exceeds a threshold. In some examples, the dispatcher scaling manager 745 may be configured as or otherwise support a means for assigning, by the DMS, a set of multiple dispatchers to the first job group based on the quantity of jobs assigned to the first job group exceeding the threshold, where scheduling for execution the one or more first jobs assigned to the first job group includes scheduling for execution a first subset of the one or more first jobs by a first dispatcher of the set of multiple dispatchers and scheduling for execution a second subset of the one or more first jobs by a second dispatcher of the set of multiple dispatchers.

In some examples, the semaphore availability manager 750 may be configured as or otherwise support a means for identifying, at a first time subsequent to scheduling the one or more first jobs for execution, an unavailability of at least one semaphore of the one or more first semaphores. In some examples, the job scheduling manager 730 may be configured as or otherwise support a means for refraining, subsequent to the first time, from scheduling one or more additional jobs assigned to the first job group based on the at least one semaphore of the one or more first semaphores being unavailable.

In some examples, the semaphore availability manager 750 may be configured as or otherwise support a means for identifying, at a second time subsequent to the first time, that the one or more first semaphores are available. In some examples, the job scheduling manager 730 may be configured as or otherwise support a means for scheduling for execution, at or subsequent to the second time, one or more jobs of the one or more additional jobs assigned to the first job group. In some examples, the job execution manager 735 may be configured as or otherwise support a means for executing, based on the scheduling at or subsequent to the second time, the one or more jobs of the one or more additional jobs using the one or more first resources of the DMS corresponding to the one or more first semaphores.

In some examples, the job priority manager 760 may be configured as or otherwise support a means for identifying a first priority of the first job group and a second priority of the second job group, where the first priority is higher than the second priority, and where at least one semaphore is included in both the one or more first semaphores and the one or more second semaphores. In some examples, the semaphore availability manager 750 may be configured as or otherwise support a means for identifying, at a second time subsequent to the first time, that the one or more first semaphores are available. In some examples, the job scheduling manager 730 may be configured as or otherwise support a means for scheduling for execution, at or subsequent to the second time, one or more jobs of the one or more additional jobs assigned to the first job group based on the first priority being higher than the second priority. In some examples, the job scheduling manager 730 may be configured as or otherwise support a means for refraining from scheduling for execution, at or subsequent to the second time, one or more second additional jobs of the second job group based on the first priority being higher than the second priority.

In some examples, the job group assignment manager 725 may be configured as or otherwise support a means for assigning, by the DMS, a third set of jobs to a third job group from the set of multiple job groups based on the third set of jobs and the third job group both being associated with one or more third semaphores. In some examples, the job scheduling manager 730 may be configured as or otherwise support a means for scheduling for execution, by at least one of the one or more dispatchers of the DMS, one or more third jobs assigned to the third job group based on the one or more third semaphores being available. In some examples, the job execution manager 735 may be configured as or otherwise support a means for executing, based on the scheduling, the one or more third jobs using one or more third resources of the DMS corresponding to the one or more third semaphores.

In some examples, the job metadata database manager 755 may be configured as or otherwise support a means for storing, by the DMS and in a data store accessible to the DMS, first metadata indicating that the first set of jobs and that the first set of jobs are associated with the first job group and second metadata indicating that the second set of jobs and that the second set of jobs are associated with the second job group.

In some examples, the job scheduling manager 730 may be configured as or otherwise support a means for obtaining, by the one or more dispatchers, the first metadata and the second metadata, where the scheduling is based on the obtaining.

In some examples, the job priority manager 760 may be configured as or otherwise support a means for identifying, by the DMS, a first priority of the first job group and a second priority of the second job group, where the first priority is higher than the second priority, where at least one semaphore is included in both the one or more first semaphores and the one or more second semaphores, and where the scheduling includes scheduling the one or more first jobs for execution prior to scheduling the one or more second jobs for execution based on the first priority being higher than the second priority.

In some examples, the one or more first resources and the one or more second resources include memory of the DMS, disk space of the DMS, communication channels within the DMS, communication channels with external computing objects, or any combination thereof.

In some examples, the backup scheduling manager 765 may be configured as or otherwise support a means for receiving, by the DMS, an indication to perform a backup operation or a recovery operation for a computing object. In some examples, the backup scheduling manager 765 may be configured as or otherwise support a means for identifying a set of multiple jobs associated with the backup operation or the recovery operation, where the set of multiple jobs include the first set of jobs and the second set of jobs.

FIG. 8 shows a block diagram 800 of a system 805 that supports job scheduling for a DMS based on job groups in accordance with aspects of the present disclosure. The system 805 may be an example of or include components of a system 605 as described herein. The system 805 may include components for data management, including components such as a DMS Manager 820, an input information 810, an output information 815, a network interface 825, at least one memory 830, at least one processor 835, and a storage 840. These components may be in electronic communication or otherwise coupled with each other (e.g., operatively, communicatively, functionally, electronically, electrically; via one or more buses, communications links, communications interfaces, or any combination thereof). Additionally, the components of the system 805 may include corresponding physical components or may be implemented as corresponding virtual components (e.g., components of one or more virtual machines). In some examples, the system 805 may be an example of aspects of one or more components described with reference to FIG. 1, such as a DMS 110.

The network interface 825 may enable the system 805 to exchange information (e.g., input information 810, output information 815, or both) with other systems or devices (not shown). For example, the network interface 825 may enable the system 805 to connect to a network (e.g., a network 120 as described herein). The network interface 825 may include one or more wireless network interfaces, one or more wired network interfaces, or any combination thereof. In some examples, the network interface 825 may be an example of may be an example of aspects of one or more components described with reference to FIG. 1, such as one or more network interfaces 165.

Memory 830 may include RAM, ROM, or both. The memory 830 may store computer-readable, computer-executable software including instructions that, when executed, cause the processor 835 to perform various functions described herein. In some cases, the memory 830 may contain, among other things, a basic input/output system (BIOS), which may control basic hardware or software operation such as the interaction with peripheral components or devices. In some cases, the memory 830 may be an example of aspects of one or more components described with reference to FIG. 1, such as one or more memories 175.

The processor 835 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 835 may be configured to execute computer-readable instructions stored in a memory 830 to perform various functions (e.g., functions or tasks supporting job scheduling for a DMS based on job groups). Though a single processor 835 is depicted in the example of FIG. 8, it is to be understood that the system 805 may include any quantity of one or more of processors 835 and that a group of processors 835 may collectively perform one or more functions ascribed herein to a processor, such as the processor 835. In some cases, the processor 835 may be an example of aspects of one or more components described with reference to FIG. 1, such as one or more processors 170.

Storage 840 may be configured to store data that is generated, processed, stored, or otherwise used by the system 805. In some cases, the storage 840 may include one or more HDDs, one or more SDDs, or both. In some examples, the storage 840 may be an example of a single database, a distributed database, multiple distributed databases, a data store, a data lake, or an emergency backup database. In some examples, the storage 840 may be an example of one or more components described with reference to FIG. 1, such as one or more network disks 180.

For example, the DMS Manager 820 may be configured as or otherwise support a means for assigning, by a DMS, a first set of jobs to a first job group from a set of multiple job groups based on the first set of jobs and the first job group both being associated with one or more first semaphores. The DMS Manager 820 may be configured as or otherwise support a means for assigning, by the DMS, a second set of jobs to a second job group from the set of multiple job groups based on the second set of jobs and the second job group both being associated with one or more second semaphores. The DMS Manager 820 may be configured as or otherwise support a means for scheduling for execution, by one or more dispatchers of the DMS, one or more first jobs assigned to the first job group based on the one or more first semaphores being available and one or more second jobs assigned to the second job group based on the one or more second semaphores being available. The DMS Manager 820 may be configured as or otherwise support a means for executing, based at least in part on the scheduling, the one or more first jobs using one or more first resources of the DMS corresponding to the one or more first semaphores. The DMS Manager 820 may be configured as or otherwise support a means for executing, based at least in part on the scheduling, the one or more second jobs using one or more second resources of the DMS corresponding to the one or more second semaphores.

By including or configuring the DMS Manager 820 in accordance with examples as described herein, the system 805 may support techniques for job scheduling for a DMS based on job groups, which may provide one or more benefits such as, for example, reduced latency, improved user experience, more efficient utilization of computing resources, network resources or both, or improved scalability, among other possibilities.

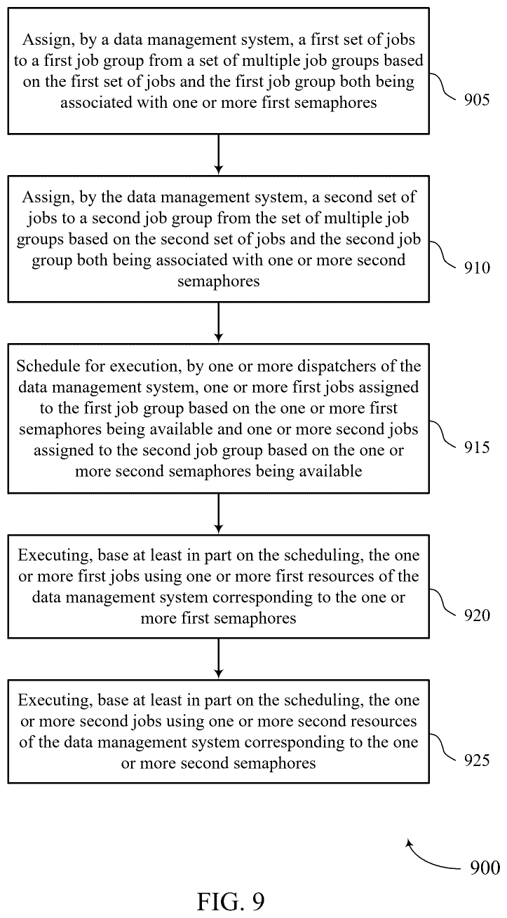

FIG. 9 shows a flowchart illustrating a method 900 that supports job scheduling for a DMS based on job groups in accordance with aspects of the present disclosure. The operations of the method 900 may be implemented by a DMS or its components as described herein. For example, the operations of the method 900 may be performed by a DMS as described with reference to FIGS. 1 through 8. In some examples, a DMS may execute a set of instructions to control the functional elements of the DMS to perform the described functions. Additionally, or alternatively, the DMS may perform aspects of the described functions using special-purpose hardware.

At 905, the method may include assigning, by a DMS, a first set of jobs to a first job group from a set of multiple job groups based on the first set of jobs and the first job group both being associated with one or more first semaphores. The operations of 905 may be performed in accordance with examples as disclosed herein. In some examples, aspects of the operations of 905 may be performed by a job group assignment manager 725 as described with reference to FIG. 7.

At 910, the method may include assigning, by the DMS, a second set of jobs to a second job group from the set of multiple job groups based on the second set of jobs and the second job group both being associated with one or more second semaphores. The operations of 910 may be performed in accordance with examples as disclosed herein. In some examples, aspects of the operations of 910 may be performed by a job group assignment manager 725 as described with reference to FIG. 7.

At 915, the method may include scheduling for execution, by one or more dispatchers of the DMS, one or more first jobs assigned to the first job group based on the one or more first semaphores being available and one or more second jobs assigned to the second job group based on the one or more second semaphores being available. The operations of 915 may be performed in accordance with examples as disclosed herein. In some examples, aspects of the operations of 915 may be performed by a job scheduling manager 730 as described with reference to FIG. 7.

At 920, the method may include executing, based on the scheduling, the one or more first jobs using one or more first resources of the DMS corresponding to the one or more first semaphores. The operations of 920 may be performed in accordance with examples as disclosed herein. In some examples, aspects of the operations of 920 may be performed by a job execution manager 735 as described with reference to FIG. 7.

At 925, the method may include executing, based on the scheduling, the one or more second jobs using one or more second resources of the DMS corresponding to the one or more second semaphores. The operations of 925 may be performed in accordance with examples as disclosed herein. In some examples, aspects of the operations of 925 may be performed by a job execution manager 735 as described with reference to FIG. 7.

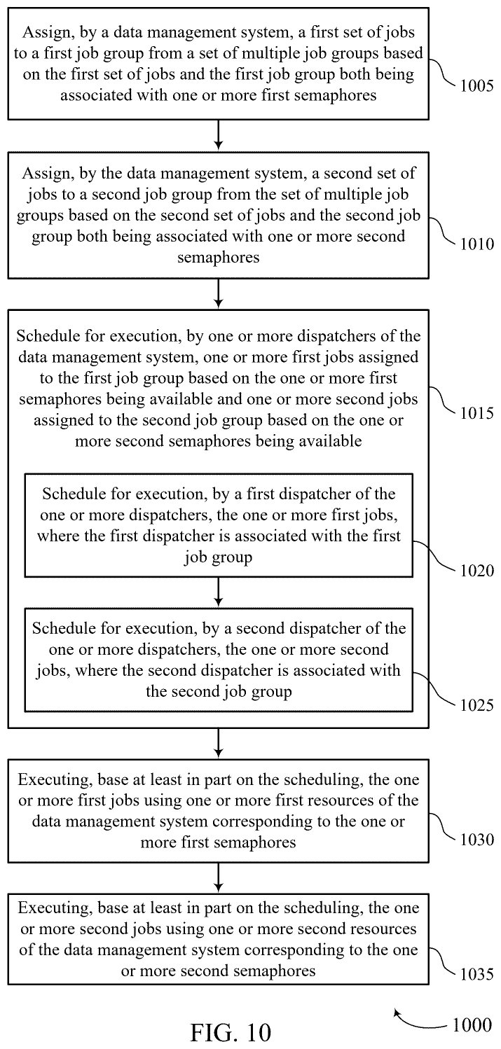

FIG. 10 shows a flowchart illustrating a method 1000 that supports job scheduling for a DMS based on job groups in accordance with aspects of the present disclosure. The operations of the method 1000 may be implemented by a DMS or its components as described herein. For example, the operations of the method 1000 may be performed by a DMS as described with reference to FIGS. 1 through 8. In some examples, a DMS may execute a set of instructions to control the functional elements of the DMS to perform the described functions. Additionally, or alternatively, the DMS may perform aspects of the described functions using special-purpose hardware.

At 1005, the method may include assigning, by a DMS, a first set of jobs to a first job group from a set of multiple job groups based on the first set of jobs and the first job group both being associated with one or more first semaphores. The operations of 1005 may be performed in accordance with examples as disclosed herein. In some examples, aspects of the operations of 1005 may be performed by a job group assignment manager 725 as described with reference to FIG. 7.

At 1010, the method may include assigning, by the DMS, a second set of jobs to a second job group from the set of multiple job groups based on the second set of jobs and the second job group both being associated with one or more second semaphores. The operations of 1010 may be performed in accordance with examples as disclosed herein. In some examples, aspects of the operations of 1010 may be performed by a job group assignment manager 725 as described with reference to FIG. 7.

At 1015, the method may include scheduling for execution, by one or more dispatchers of the DMS, one or more first jobs assigned to the first job group based on the one or more first semaphores being available and one or more second jobs assigned to the second job group based on the one or more second semaphores being available. The operations of 1015 may be performed in accordance with examples as disclosed herein. In some examples, aspects of the operations of 1015 may be performed by a job scheduling manager 730 as described with reference to FIG. 7.

In some examples, scheduling for execution the one or more first jobs and the one or more second jobs may include, at 1020, scheduling for execution, by a first dispatcher of the one or more dispatchers, the one or more first jobs, where the first dispatcher is associated with the first job group. The operations of 1020 may be performed in accordance with examples as disclosed herein. In some examples, aspects of the operations of 1020 may be performed by a per job group dispatcher manager 740 as described with reference to FIG. 7. In some examples, scheduling for execution the one or more first jobs and the one or more second jobs may further include, at 1025, include scheduling for execution, by a second dispatcher of the one or more dispatchers, the one or more second jobs, where the second dispatcher is associated with the second job group. The operations of 1025 may be performed in accordance with examples as disclosed herein. In some examples, aspects of the operations of 1025 may be performed by a per job group dispatcher manager 740 as described with reference to FIG. 7.

At 1030, the method may include executing, based on the scheduling, the one or more first jobs using one or more first resources of the DMS corresponding to the one or more first semaphores. The operations of 1030 may be performed in accordance with examples as disclosed herein. In some examples, aspects of the operations of 1030 may be performed by a job execution manager 735 as described with reference to FIG. 7.

At 1035, the method may include executing, based on the scheduling, the one or more second jobs using one or more second resources of the DMS corresponding to the one or more second semaphores. The operations of 1035 may be performed in accordance with examples as disclosed herein. In some examples, aspects of the operations of 1035 may be performed by a job execution manager 735 as described with reference to FIG. 7.

A method by an apparatus is described. The method may include assigning, by a DMS, a first set of jobs to a first job group from a set of multiple job groups based on the first set of jobs and the first job group both being associated with one or more first semaphores, assigning, by the DMS, a second set of jobs to a second job group from the set of multiple job groups based on the second set of jobs and the second job group both being associated with one or more second semaphores, scheduling for execution, by one or more dispatchers of the DMS, one or more first jobs assigned to the first job group based on the one or more first semaphores being available and one or more second jobs assigned to the second job group based on the one or more second semaphores being available, executing, based on the scheduling, the one or more first jobs using one or more first resources of the DMS corresponding to the one or more first semaphores, and executing, based on the scheduling, the one or more second jobs using one or more second resources of the DMS corresponding to the one or more second semaphores.

An apparatus is described. The apparatus may include one or more memories storing processor executable code, and one or more processors coupled with the one or more memories. The one or more processors may individually or collectively be operable to execute the code to cause the apparatus to assign, by a DMS, a first set of jobs to a first job group from a set of multiple job groups based on the first set of jobs and the first job group both being associated with one or more first semaphores, assign, by the DMS, a second set of jobs to a second job group from the set of multiple job groups based on the second set of jobs and the second job group both being associated with one or more second semaphores, schedule for execution, by one or more dispatchers of the DMS, one or more first jobs assigned to the first job group based on the one or more first semaphores being available and one or more second jobs assigned to the second job group based on the one or more second semaphores being available, executing, based at least in part on the scheduling, the one or more first jobs using one or more first resources of the DMS corresponding to the one or more first semaphores, and executing, based at least in part on the scheduling, the one or more second jobs using one or more second resources of the DMS corresponding to the one or more second semaphores.

Another apparatus is described. The apparatus may include means for assigning, by a DMS, a first set of jobs to a first job group from a set of multiple job groups based on the first set of jobs and the first job group both being associated with one or more first semaphores, means for assigning, by the DMS, a second set of jobs to a second job group from the set of multiple job groups based on the second set of jobs and the second job group both being associated with one or more second semaphores, means for scheduling for execution, by one or more dispatchers of the DMS, one or more first jobs assigned to the first job group based on the one or more first semaphores being available and one or more second jobs assigned to the second job group based on the one or more second semaphores being available, means for executing, based on the scheduling, the one or more first jobs using one or more first resources of the DMS corresponding to the one or more first semaphores, and means for executing, based on the scheduling, the one or more second jobs using one or more second resources of the DMS corresponding to the one or more second semaphores.

A non-transitory computer-readable medium storing code is described. The code may include instructions executable by one or more processors to assign, by a DMS, a first set of jobs to a first job group from a set of multiple job groups based on the first set of jobs and the first job group both being associated with one or more first semaphores, assign, by the DMS, a second set of jobs to a second job group from the set of multiple job groups based on the second set of jobs and the second job group both being associated with one or more second semaphores, schedule for execution, by one or more dispatchers of the DMS, one or more first jobs assigned to the first job group based on the one or more first semaphores being available and one or more second jobs assigned to the second job group based on the one or more second semaphores being available, executing, based at least in part on the scheduling, the one or more first jobs using one or more first resources of the DMS corresponding to the one or more first semaphores, and executing, based at least in part on the scheduling, the one or more second jobs using one or more second resources of the DMS corresponding to the one or more second semaphores.

In some examples of the method, apparatus, and non-transitory computer-readable medium described herein, operations, features, means, or instructions for scheduling for execution the one or more first jobs and the one or more second jobs may include operations, features, means, or instructions for scheduling for execution, by a first dispatcher of the one or more dispatchers, the one or more first jobs, where the first dispatcher may be associated with the first job group and scheduling for execution, by a second dispatcher of the one or more dispatchers, the one or more second jobs, where the second dispatcher may be associated with the second job group.

In some examples of the method, apparatus, and non-transitory computer-readable medium described herein, the scheduling for execution of the one or more first jobs by the first dispatcher occurs in parallel with the scheduling for execution of the one or more second jobs by the second dispatcher.

Some examples of the method, apparatus, and non-transitory computer-readable medium described herein may further include operations, features, means, or instructions for identifying, by the DMS, that a quantity of jobs assigned to the first job group exceeds a threshold and assigning, by the DMS, a set of multiple dispatchers to the first job group based on the quantity of jobs assigned to the first job group exceeding the threshold, where scheduling for execution the one or more first jobs assigned to the first job group includes scheduling for execution a first subset of the one or more first jobs by a first dispatcher of the set of multiple dispatchers and scheduling for execution a second subset of the one or more first jobs by a second dispatcher of the set of multiple dispatchers.

Some examples of the method, apparatus, and non-transitory computer-readable medium described herein may further include operations, features, means, or instructions for identifying, at a first time subsequent to scheduling the one or more first jobs for execution, an unavailability of at least one semaphore of the one or more first semaphores and refraining, subsequent to the first time, from scheduling one or more additional jobs assigned to the first job group based on the at least one semaphore of the one or more first semaphores being unavailable.

Some examples of the method, apparatus, and non-transitory computer-readable medium described herein may further include operations, features, means, or instructions for identifying, at a second time subsequent to the first time, that the one or more first semaphores may be available, scheduling for execution, at or subsequent to the second time, one or more jobs of the one or more additional jobs assigned to the first job group, and executing, based on the scheduling at or subsequent to the second time, the one or more jobs of the one or more additional jobs using the one or more first resources of the DMS corresponding to the one or more first semaphores.

Some examples of the method, apparatus, and non-transitory computer-readable medium described herein may further include operations, features, means, or instructions for identifying a first priority of the first job group and a second priority of the second job group, where the first priority may be higher than the second priority, and where at least one semaphore may be included in both the one or more first semaphores and the one or more second semaphores, identifying, at a second time subsequent to the first time, that the one or more first semaphores may be available, scheduling for execution, at or subsequent to the second time, one or more jobs of the one or more additional jobs assigned to the first job group based on the first priority being higher than the second priority, and refraining from scheduling for execution, at or subsequent to the second time, one or more second additional jobs of the second job group based on the first priority being higher than the second priority.

Some examples of the method, apparatus, and non-transitory computer-readable medium described herein may further include operations, features, means, or instructions for assigning, by the DMS, a third set of jobs to a third job group from the set of multiple job groups based on the third set of jobs and the third job group both being associated with one or more third semaphores, scheduling for execution, by at least one of the one or more dispatchers of the DMS, one or more third jobs assigned to the third job group based on the one or more third semaphores being available, and executing, based on the scheduling, the one or more third jobs using one or more third resources of the DMS corresponding to the one or more third semaphores.

Some examples of the method, apparatus, and non-transitory computer-readable medium described herein may further include operations, features, means, or instructions for storing, by the DMS and in a data store accessible to the DMS, first metadata indicating that the first set of jobs and that the first set of jobs may be associated with the first job group and second metadata indicating that the second set of jobs and that the second set of jobs may be associated with the second job group.

Some examples of the method, apparatus, and non-transitory computer-readable medium described herein may further include operations, features, means, or instructions for obtaining, by the one or more dispatchers, the first metadata and the second metadata, where the scheduling may be based on the obtaining.

Some examples of the method, apparatus, and non-transitory computer-readable medium described herein may further include operations, features, means, or instructions for identifying, by the DMS, a first priority of the first job group and a second priority of the second job group, where the first priority may be higher than the second priority, where at least one semaphore may be included in both the one or more first semaphores and the one or more second semaphores, and where the scheduling includes scheduling the one or more first jobs for execution prior to scheduling the one or more second jobs for execution based on the first priority being higher than the second priority.

In some examples of the method, apparatus, and non-transitory computer-readable medium described herein, the one or more first resources and the one or more second resources include memory of the DMS, disk space of the DMS, communication channels within the DMS, communication channels with external computing objects, or any combination thereof.

Some examples of the method, apparatus, and non-transitory computer-readable medium described herein may further include operations, features, means, or instructions for receiving, by the DMS, an indication to perform a backup operation or a recovery operation for a computing object and identifying a set of multiple jobs associated with the backup operation or the recovery operation, where the set of multiple jobs include the first set of jobs and the second set of jobs.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, “a component” having characteristics or performing functions may refer to “at least one of one or more components” having a particular characteristic or performing a particular function. Subsequent reference to a component introduced with the article “a” using the terms “the” or “said” refers to any or all of the one or more components. For example, a component introduced with the article “a” shall be understood to mean “one or more components,” and referring to “the component” subsequently in the claims shall be understood to be equivalent to referring to “at least one of the one or more components.”

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
assigning, by a data management system, a first set of jobs to a first job group from a plurality of job groups based at least in part on the first set of jobs and the first job group both being associated with one or more first semaphores;
assigning, by the data management system, a second set of jobs to a second job group from the plurality of job groups based at least in part on the second set of jobs and the second job group both being associated with one or more second semaphores;
scheduling for execution, by one or more dispatchers of the data management system, one or more first jobs assigned to the first job group based at least in part on the one or more first semaphores being available and one or more second jobs assigned to the second job group based at least in part on the one or more second semaphores being available;
executing, based at least in part on the scheduling, the one or more first jobs using one or more first resources of the data management system corresponding to the one or more first semaphores; and
executing, based at least in part on the scheduling, the one or more second jobs using one or more second resources of the data management system corresponding to the one or more second semaphores.

2. The method of claim 1, wherein scheduling for execution the one or more first jobs and the one or more second jobs comprises:
scheduling for execution, by a first dispatcher of the one or more dispatchers, the one or more first jobs, wherein the first dispatcher is associated with the first job group; and
scheduling for execution, by a second dispatcher of the one or more dispatchers, the one or more second jobs, wherein the second dispatcher is associated with the second job group.

3. The method of claim 2, wherein the scheduling for execution of the one or more first jobs by the first dispatcher occurs in parallel with the scheduling for execution of the one or more second jobs by the second dispatcher.

4. The method of claim 1, further comprising:
identifying, by the data management system, that a quantity of jobs assigned to the first job group exceeds a threshold; and
assigning, by the data management system, a plurality of dispatchers to the first job group based at least in part on the quantity of jobs assigned to the first job group exceeding the threshold, wherein scheduling for execution the one or more first jobs assigned to the first job group comprises scheduling for execution a first subset of the one or more first jobs by a first dispatcher of the plurality of dispatchers and scheduling for execution a second subset of the one or more first jobs by a second dispatcher of the plurality of dispatchers.

5. The method of claim 1, further comprising:
identifying, at a first time subsequent to scheduling the one or more first jobs for execution, an unavailability of at least one semaphore of the one or more first semaphores; and
refraining, subsequent to the first time, from scheduling one or more additional jobs assigned to the first job group based at least in part on the at least one semaphore of the one or more first semaphores being unavailable.

6. The method of claim 5, further comprising:
identifying, at a second time subsequent to the first time, that the one or more first semaphores are available;
scheduling for execution, at or subsequent to the second time, one or more jobs of the one or more additional jobs assigned to the first job group; and
executing, based at least in part on the scheduling at or subsequent to the second time, the one or more jobs of the one or more additional jobs using the one or more first resources of the data management system corresponding to the one or more first semaphores.

7. The method of claim 5, further comprising:
identifying a first priority of the first job group and a second priority of the second job group, wherein the first priority is higher than the second priority, and wherein at least one semaphore is included in both the one or more first semaphores and the one or more second semaphores;
identifying, at a second time subsequent to the first time, that the one or more first semaphores are available;
scheduling for execution, at or subsequent to the second time, one or more jobs of the one or more additional jobs assigned to the first job group based at least in part on the first priority being higher than the second priority; and
refraining from scheduling for execution, at or subsequent to the second time, one or more second additional jobs of the second job group based at least in part on the first priority being higher than the second priority.

8. The method of claim 1, further comprising:
assigning, by the data management system, a third set of jobs to a third job group from the plurality of job groups based at least in part on the third set of jobs and the third job group both being associated with one or more third semaphores;
scheduling for execution, by at least one of the one or more dispatchers of the data management system, one or more third jobs assigned to the third job group based at least in part on the one or more third semaphores being available; and
executing, based at least in part on the scheduling, the one or more third jobs using one or more third resources of the data management system corresponding to the one or more third semaphores.

9. The method of claim 1, further comprising:
storing, by the data management system and in a data store accessible to the data management system, first metadata indicating that the first set of jobs and that the first set of jobs are associated with the first job group and second metadata indicating that the second set of jobs and that the second set of jobs are associated with the second job group.

10. The method of claim 9, further comprising:
obtaining, by the one or more dispatchers, the first metadata and the second metadata, wherein the scheduling is based at least in part on the obtaining.

11. The method of claim 1, further comprising:
identifying, by the data management system, a first priority of the first job group and a second priority of the second job group, wherein the first priority is higher than the second priority, wherein at least one semaphore is included in both the one or more first semaphores and the one or more second semaphores, and wherein the scheduling comprises scheduling the one or more first jobs for execution prior to scheduling the one or more second jobs for execution based at least in part on the first priority being higher than the second priority.

12. The method of claim 1, wherein the one or more first resources and the one or more second resources comprise memory of the data management system, disk space of the data management system, communication channels within the data management system, communication channels with external computing objects, or any combination thereof.

13. The method of claim 1, further comprising:
receiving, by the data management system, an indication to perform a backup operation or a recovery operation for a computing object; and
identifying a plurality of jobs associated with the backup operation or the recovery operation, wherein the plurality of jobs comprise the first set of jobs and the second set of jobs.

14. An apparatus, comprising:
one or more memories storing processor-executable code; and
one or more processors coupled with the one or more memories and individually or collectively operable to execute the code to cause the apparatus to:
assign, by a data management system, a first set of jobs to a first job group from a plurality of job groups based at least in part on the first set of jobs and the first job group both being associated with one or more first semaphores;
assign, by the data management system, a second set of jobs to a second job group from the plurality of job groups based at least in part on the second set of jobs and the second job group both being associated with one or more second semaphores;
schedule for execution, by one or more dispatchers of the data management system, one or more first jobs assigned to the first job group based at least in part on the one or more first semaphores being available and one or more second jobs assigned to the second job group based at least in part on the one or more second semaphores being available;
execute, based at least in part on the scheduling, the one or more first jobs using one or more first resources of the data management system corresponding to the one or more first semaphores; and
execute, based at least in part on the scheduling, the one or more second jobs using one or more second resources of the data management system corresponding to the one or more second semaphores.

15. The apparatus of claim 14, wherein, to schedule for execution the one or more first jobs and the one or more second jobs, the one or more processors are individually or collectively operable to execute the code to cause the apparatus to:
schedule for execution, by a first dispatcher of the one or more dispatchers, the one or more first jobs, wherein the first dispatcher is associated with the first job group; and
schedule for execution, by a second dispatcher of the one or more dispatchers, the one or more second jobs, wherein the second dispatcher is associated with the second job group.

16. The apparatus of claim 15, wherein the one or more processors are individually or collectively operable to execute the code to cause the apparatus to schedule, by the first dispatcher, the one or more first jobs and schedule, by the second dispatcher, the one or more second jobs in parallel.

17. The apparatus of claim 14, wherein the one or more processors are individually or collectively further operable to execute the code to cause the apparatus to:
identify, by the data management system, that a quantity of jobs assigned to the first job group exceeds a threshold; and
assign, by the data management system, a plurality of dispatchers to the first job group based at least in part on the quantity of jobs assigned to the first job group exceeding the threshold, wherein, to schedule for execution the one or more first jobs assigned to the first job group, the one or more processors are individually or collectively operable to execute the code to cause the apparatus to schedule for execution a first subset of the one or more first jobs by a first dispatcher of the plurality of dispatchers and schedule for execution a second subset of the one or more first jobs by a second dispatcher of the plurality of dispatchers.

18. The apparatus of claim 14, wherein the one or more processors are individually or collectively further operable to execute the code to cause the apparatus to:
identify, at a first time subsequent to scheduling the one or more first jobs for execution, an unavailability of at least one semaphore of the one or more first semaphores; and
refrain, subsequent to the first time, from scheduling one or more additional jobs assigned to the first job group based at least in part on the at least one semaphore of the one or more first semaphores being unavailable.

19. The apparatus of claim 18, wherein the one or more processors are individually or collectively further operable to execute the code to cause the apparatus to:
identify, at a second time subsequent to the first time, that the one or more first semaphores are available;
schedule for execution, at or subsequent to the second time, one or more jobs of the one or more additional jobs assigned to the first job group; and
execute, based at least in part on the scheduling at or subsequent to the second time, the one or more jobs of the one or more additional jobs using the one or more first resources of the data management system corresponding to the one or more first semaphores.

20. A non-transitory computer-readable medium storing code, the code comprising instructions executable by one or more processors to:
assign, by a data management system, a first set of jobs to a first job group from a plurality of job groups based at least in part on the first set of jobs and the first job group both being associated with one or more first semaphores;
assign, by the data management system, a second set of jobs to a second job group from the plurality of job groups based at least in part on the second set of jobs and the second job group both being associated with one or more second semaphores;
schedule for execution, by one or more dispatchers of the data management system, one or more first jobs assigned to the first job group based at least in part on the one or more first semaphores being available and one or more second jobs assigned to the second job group based at least in part on the one or more second semaphores being available;
execute, based at least in part on the scheduling, the one or more first jobs using one or more first resources of the data management system corresponding to the one or more first semaphores; and
execute, based at least in part on the scheduling, the one or more second jobs using one or more second resources of the data management system corresponding to the one or more second semaphores.
